(19) United States
(12) Patent Application Publication
(10) Pub. No.: US 2026/0281456 A1
(43) Pub. Date: Sep. 17, 2026

(54) IMAGE ENCODING/DECODING METHOD AND DEVICE, AND RECORDING MEDIUM ON WHICH BITSTREAM IS STORED

(71) Applicant: LG ELECTRONICS INC., Seoul (KR)

(72) Inventors: Jangwon LEE, Seoul (KR); Jaehyun LIM, Seoul (KR); Chulkeun KIM, Seoul (KR); Junghak NAM, Seoul (KR); Seunghwan KIM, Seoul (KR); Hendry TAN, Seoul (KR)

(73) Assignee: LG ELECTRONICS INC., Seoul (KR)

(21) Appl. No.: 19/670,831

(22) Filed: May 7, 2026

Related U.S. Application Data
(63) Continuation of application No. PCT/KR2026/000106, filed on Jan. 2, 2026.
(60) Provisional application No. 63/741,469, filed on Jan. 3, 2025.

(51) Int. Cl. H04N 19/70; H04N 19/169; H04N 19/172; H04N 19/503; H04N 19/593

(52) U.S. Cl. CPC H04N 19/70; H04N 19/172; H04N 19/188; H04N 19/503; H04N 19/593

(57) ABSTRACT

An image decoding method and apparatus according to the present disclosure may receive a bitstream including an encoded video picture and may reconstruct the encoded video picture included in the bitstream. Here, the bitstream may include a generative face video supplementary enhancement information (SEI) message. The generative face video SEI message may include at least one of a base picture flag indicating whether a currently decoded output picture corresponds to a base picture or a matrix prediction flag indicating whether matrix element difference value information is present.

### CROSS-REFERENCE TO RELATED APPLICATIONS

This application is a continuation of International Application No. PCT/KR2026/000106, filed on Jan. 2, 2026, which claims the benefit of U.S. Provisional Patent Application No. 63/741,469, filed on Jan. 3, 2025, the contents of which are all incorporated by reference herein in their entireties.

### TECHNICAL FIELD

present disclosure relates to an image encoding/decoding method and apparatus, and a recording medium storing a bitstream.

### BACKGROUND

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### SUMMARY

The present disclosure is to provide a method and an apparatus for configuring a generative face video supplementary enhancement information (SEI) message including generative face video information.

The present disclosure is to provide a method and an apparatus for signaling a generative face video SEI message.

An image decoding method and apparatus according to the present disclosure may receive a bitstream including an encoded video picture, and reconstruct the encoded video picture included in the bitstream. The bitstream may include a generative face video supplementary enhancement information (SEI) message.

In the image decoding method and apparatus according to the present disclosure, the generative face video SEI message may include at least one of a base picture flag indicating whether a currently decoded output picture corresponds to a base picture, or a matrix prediction flag indicating whether matrix element difference value information is present.

In the image decoding method and apparatus according to the present disclosure, the generative face video SEI message may be obtained from a network abstraction layer (NAL) unit of the bitstream.

In the image decoding method and apparatus according to the present disclosure, a value of the matrix prediction flag being equal to 0 may indicate that matrix element value information is present, and the value of the matrix prediction flag being equal to 1 may indicate that matrix element difference value information is present. Here, the matrix element value information may include at least one of matrix element integer value information or matrix element decimal value information, and the matrix element difference value information may include at least one of matrix element integer difference value information or matrix element decimal difference value information.

In the image decoding method and apparatus according to the present disclosure, the generative face video SEI message may include matrix precision information indicating a precision of a matrix element, and the matrix precision information may be signaled based on the matrix prediction flag.

In the image decoding method and apparatus according to the present disclosure, when a value of the matrix prediction flag is equal to 0, the matrix precision information may be signaled, and when the value of the matrix prediction flag is equal to 1, the matrix precision information may not be signaled regardless of a value of the base picture flag.

In the image decoding method and apparatus according to the present disclosure, the generative face video SEI message may include matrix type number information indicating a number of matrix types, and the matrix type number information may be signaled based on the matrix prediction flag.

In the image decoding method and apparatus according to the present disclosure, when a value of the matrix prediction flag is equal to 0, the matrix type number information may be signaled, and when the value of the matrix prediction flag is equal to 1, the matrix type number information may not be signaled regardless of a value of the base picture flag.

In the image decoding method and apparatus according to the present disclosure, the generative face video SEI message may include matrix type information indicating a type of a matrix included in the generative face video SEI message, and the matrix type information may be signaled based on at least one of the matrix prediction flag or the matrix type number information.

In the image decoding method and apparatus according to the present disclosure, when a value of the matrix prediction flag is equal to 0, the matrix type information may be signaled, and when the value of the matrix prediction flag is equal to 1, the matrix type information may not be signaled regardless of a value of the base picture flag.

In the image decoding method and apparatus according to the present disclosure, the generative face video SEI message may include matrix related information by matrix type, and the matrix related information by matrix type may be signaled based on at least one of the matrix prediction flag or the matrix type information. Here, the matrix related information may include at least one of matrix number information indicating a number of matrices by matrix type, matrix width information indicating a width of a matrix by matrix type, or matrix height information indicating a height of a matrix by matrix type.

In the image decoding method and apparatus according to the present disclosure, when a value of the matrix prediction flag is equal to 0, the matrix related information by matrix type may be signaled, and when the value of the matrix prediction flag is equal to 1, the matrix related information by matrix type may not be signaled regardless of a value of the base picture flag.

In the image decoding method and apparatus according to the present disclosure, when a value of the matrix type information is greater than or equal to 7, the matrix number information, the matrix width information, and the matrix height information may be signaled, and when the value of the matrix type information is equal to 2 or 3, the matrix width information and the matrix height information may be signaled, and the matrix number information may not be signaled.

An image encoding method and apparatus according to the present disclosure may receive a video picture to be encoded, generate video information related to the video picture by encoding the received video picture, generate a generative face video SEI message, and generate a bitstream including the video information and the generative face video SEI message. The generative face video SEI message may include at least one of a base picture flag indicating whether a currently decoded output picture corresponds to a base picture, or a matrix prediction flag indicating whether matrix element difference value information is present. The generative face video SEI message may be encoded into a network abstraction layer (NAL) unit of the bitstream.

A computer-readable digital storage medium storing encoded video/image information that causes a decoding apparatus according to the present disclosure to perform an image decoding method is provided.

A computer-readable digital storage medium storing video/image information generated according to an image encoding method according to the present disclosure is provided.

A method and an apparatus for transmitting video/image information generated according to an image encoding method according to the present disclosure are provided.

According to the present disclosure, by defining a generative face video SEI message, information related to a face parameter for generating a face image or information related to a neural network for transforming a face parameter and generating an output image may be easily identified.

According to the present disclosure, by removing redundant operations in a generative face video supplementary enhancement information (SEI) message, unnecessary operations from occurring in an image encoding/decoding apparatus may be prevented, thereby increasing the efficiency of the generative face video SEI message.

### BRIEF DESCRIPTION OF THE DRAWINGS

FIG. 1 illustrates a video/image coding system according to the present disclosure.

FIG. 2 illustrates a schematic block diagram of an encoding apparatus to which an embodiment of the present disclosure is applicable and encoding of video/image signals is performed.

FIG. 3 illustrates a schematic block diagram of a decoding apparatus to which an embodiment of the present disclosure is applicable and decoding of video/image signals is performed.

FIG. 4 illustrates a method of reconstructing a video picture performed by a decoding apparatus 300, according to the present disclosure.

FIG. 5 illustrates a schematic configuration of a decoding apparatus 300 performing a method of reconstructing a video picture, according to the present disclosure.

FIG. 6 illustrates a method of generating a bitstream performed by an encoding apparatus 200, according to the present disclosure.

FIG. 7 illustrates a schematic configuration of an encoding apparatus 200 performing a method of generating a bitstream, according to the present disclosure.

FIG. 8 illustrates an example of a contents streaming system to which embodiments of the present disclosure may be applied.

### DETAILED DESCRIPTION

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, a first component may be referred to as a second component without departing from the scope of a right of the present disclosure, and similarly, a second component may also be referred to as a first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex. H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular area composed of a plurality of CTUs within a specific tile column and a specific tile row of one picture. A tile column is a rectangular area of CTUs having the same height as that of a picture and a width designated by a syntax requirement of a picture parameter set. A tile row is a rectangular area of CTUs having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular area of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific area of a picture and information related to a corresponding area. One unit may include one luma block and two chroma (ex. cb, cr) blocks. In some cases, a unit may be used interchangeably with a term such as a block or an area, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

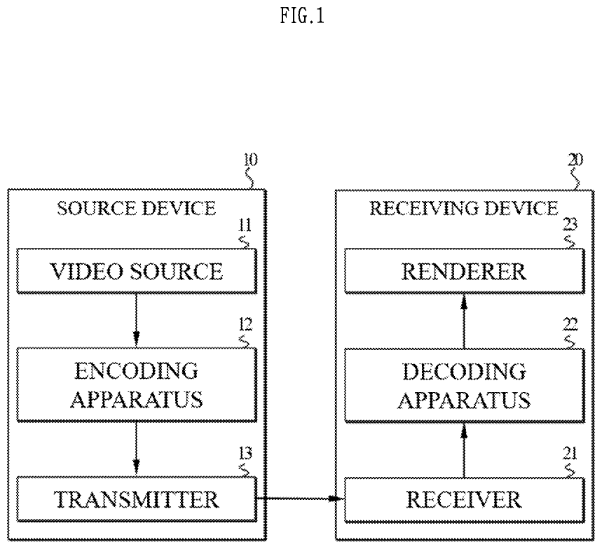

FIG. 1 shows a video/image coding system according to the present disclosure.

Referring to FIG. 1, a video/image coding system may include a first device (a source device) 10 and a second device (a receiving device) 20.

A source device 10 may transmit encoded video/image information or data in a form of a file or streaming to a receiving device 20 through a digital storage medium or a network. The source device 10 may include a video source 11, an encoding apparatus 12 and a transmitter 13. The receiving device 20 may include a receiver 21, a decoding apparatus 22 and a renderer 23. The encoding apparatus 12 may be referred to as a video/image encoding apparatus and the decoding apparatus 22 may be referred to as a video/image decoding apparatus. A transmitter may be included in an encoding apparatus. A receiver may be included in a decoding apparatus. A renderer 23 may include a display unit, and a display unit may be composed of a separate device or an external component.

A video source 11 may acquire a video/an image through a process of capturing, synthesizing or generating a video/an image. A video source 11 may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding apparatus 12 may encode an input video/image. An encoding apparatus 12 may perform a series of procedures such as prediction, transform, quantization, etc. for compression and coding efficiency. Encoded data (encoded video/image information) may be output in a form of a bitstream.

A transmitter 13 may transmit encoded video/image information or data output in a form of a bitstream to a receiver 21 of a receiving device 20 through a digital storage medium or a network in a form of a file or streaming. A digital storage medium may include various storage media such as USB, SD, CD, DVD, Blu-ray, HDD, SSD, etc. A transmitter 13 may include an element for generating a media file through a predetermined file format and may include an element for transmission through a broadcasting/communication network. A receiver 21 may receive/extract the bitstream and transmit it to a decoding apparatus 22.

A decoding apparatus 22 may decode a video/an image by performing a series of procedures such as dequantization, inverse transform, prediction, etc. corresponding to an operation of an encoding apparatus 12.

A renderer 23 may render a decoded video/image. A rendered video/image may be displayed through a display unit.

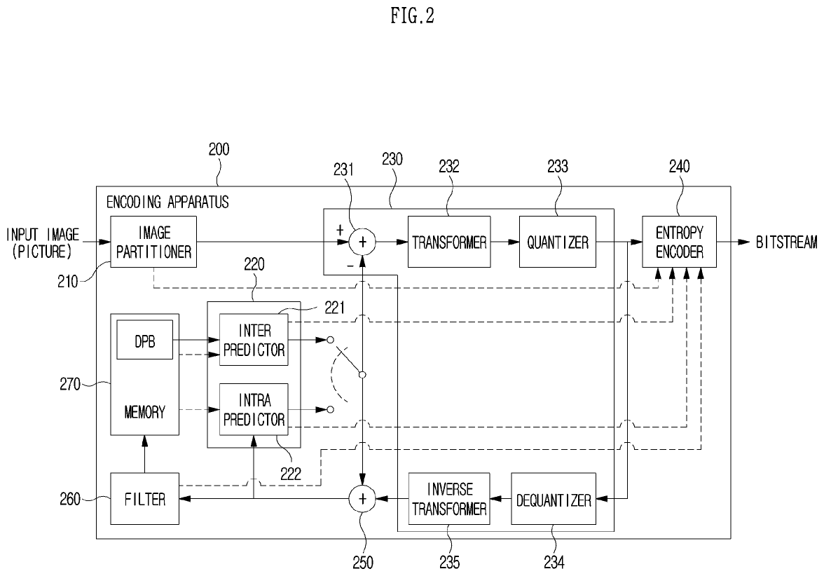

FIG. 2 shows a rough block diagram of an encoding apparatus to which an embodiment of the present disclosure may be applied and encoding of a video/image signal is performed.

Referring to FIG. 2, an encoding apparatus 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding apparatus 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an area, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding apparatus 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding apparatus 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a surrounding block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loève Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may rearrange quantized transform coefficients in a block form into an one-dimensional vector form based on coefficient scan order, and may generate information on the quantized transform coefficients based on the quantized transform coefficients in the one-dimensional vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding apparatus to a decoding apparatus may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding apparatus 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictor 221. When inter prediction is applied through it, an encoding apparatus may avoid prediction mismatch in an encoding apparatus 200 and a decoding apparatus, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

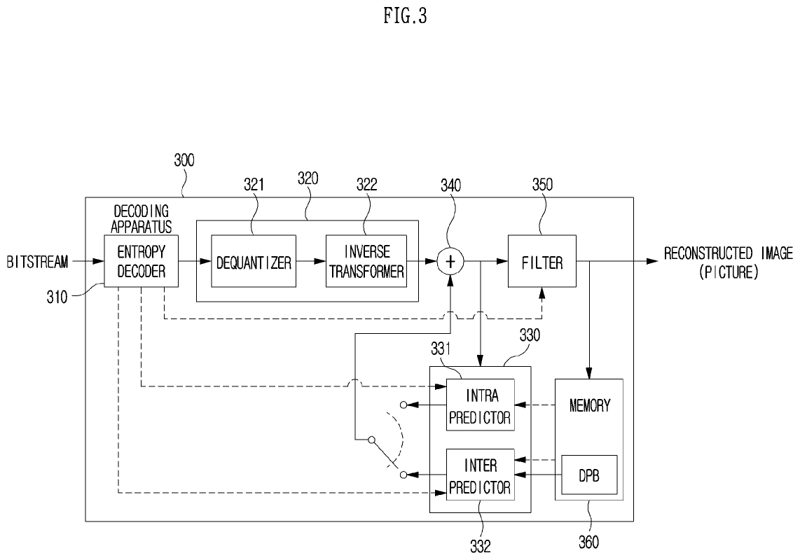

FIG. 3 shows a rough block diagram of a decoding apparatus to which an embodiment of the present disclosure may be applied and decoding of a video/image signal is performed.

Referring to FIG. 3, a decoding apparatus 300 may be configured by including an entropy decoder 310, a residual processor 320, a predictor 330, an adder 340, a filter 350 and a memory 360. A predictor 330 may include an inter predictor 332 and an intra predictor 331. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding apparatus 300 may reconstruct an image in response to a process in which video/image information is processed in an encoding apparatus of FIG. 2. For example, a decoding apparatus 300 may derive units/blocks based on block partition-related information obtained from the bitstream. A decoding apparatus 300 may perform decoding by using a processing unit applied in an encoding apparatus. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding apparatus 300 may be played through a playback device.

A decoding apparatus 300 may receive a signal output from an encoding apparatus of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding apparatus may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a surrounding block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding apparatus may be further configured as an internal/external element of a decoding apparatus 300 or a reception unit may be a component of an entropy decoder 310.

Meanwhile, a decoding apparatus according to this specification may be referred to as a video/image/picture decoding apparatus, and the decoding apparatus may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may rearrange quantized transform coefficients into a two-dimensional block form. In this case, the rearrangement may be performed based on coefficient scan order performed in an encoding apparatus. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter predictor 332. A memory 360 may store motion information of a block from which motion information in a current picture is derived (or decoded) and/or motion information of blocks in a pre-reconstructed picture. The stored motion information may be transmitted to an inter predictor 332 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding apparatus 200 may be also applied equally or correspondingly to a filter 350, an inter predictor 332 and an intra predictor 331 of a decoding apparatus 300, respectively.

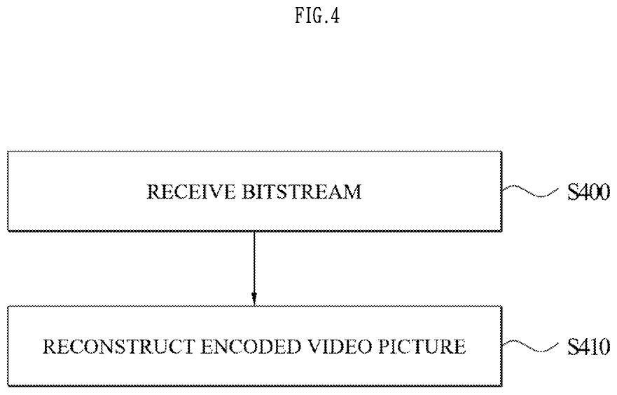

FIG. 4 illustrates a method of reconstructing a video picture performed by a decoding apparatus 300, according to the present disclosure.

A bitstream including an encoded video picture may be received S400.

The encoded video picture of the bitstream may be reconstructed S410.

Video information related to the encoded video picture may be extracted from the bitstream. The encoded video picture may be reconstructed based on the extracted video information.

The bitstream may include generative face video information. The generative face video information may be configured in a supplementary enhancement information (SEI) message of the bitstream. In this case, the SEI message may be referred to as a generative face video (GFV) SEI message.

The generative face video information may include information related to a face parameter for generating a face image, or information related to a neural network for face parameter transformation and output image generation. More specifically, the generative face video information may include information related to a face parameter translator neural network (TranslatorNN ( ) that may be used to transform face parameters of various types signaled to a decoding apparatus into a face parameter of a specific type supported by a decoding system. In addition, the generative face video information may include information related to a face picture generator neural network (GenerativeNN ( ) that may be used to generate a final output picture based on a face parameter transformed into a specific type through a face parameter translator neural network, and a previously decoded output picture.

Table 1 is an example of a generative face video SEI message included in a bitstream.

TABLE 1

| | Descriptor |
|---|---|
| generative_face_video ( payloadSize ) { | |
| gfv_id | ue(v) |
| gfv_cnt | ue(v) |
| if( gfv_cnt = = 0 ) | |
| gfv_base_pic_flag /* indicate if the current decoded output picture is a base | u(1) |
| picture */ | |
| if( gfv_base_pic_flag ) { /* specify TranslatorNN( ) */ | |
| gfv_nn_present_flag | u(1) |
| if( gfv_nn_present_flag ) { | |
| gfv_nn_mode_idc | ue(v) |
| if( gfv_nn_mode_idc = = 1 ) { | |
| while( !byte_aligned( ) ) | |
| gfv_nn_alignment_zero_bit_a | u(1) |
| gfv_nn_tag_uri | st(v) |
| gfv_nn_uri | st(v) |
| } | |
| } | |
| gfv_chroma_key_info_present_flag | u(1) |
| if( gfv_chroma_key_info_present_flag ) { | |
| for( c = 0; c < 3; c++ ) { | |
| gfv_chroma_key_value_present_flag[ c ] | u(1) |
| if( gfv_chroma_key_value_present_flag[ c ] ) | |
| gfv_chroma_key_value[ c ] | u(8) |
| } | |
| for( i = 0; i < 2; i++ ) { | |
| gfv_chroma_key_thr_present_flag[ i ] | u(1) |
| if( gfv_chroma_key_thr present_flag[ i ] ) | |
| gfv_chroma_key_thr_value[ i ] | ue(v) |
| } | |
| } | |
| } else | |
| gfv_drive_pic_fusion_flag /* indicate if DrivePicture is input to GenerativeNN( ) | u(1) |
| */ | |
| gfv_low_confidence_face_parameter_flag | u(1) |
| gfv_coordinate_present_flag | u(1) |
| if( gfv_coordinate_present_flag ) { | |
| gfv_kps_pred_flag | u(1) |
| if( gfv_base_pic_flag \| \| !gfv_kps_pred_flag ) { | |
| gfv_coordinate_precision_factor_minus1 | ue(v) |
| gfv_num_kps_minus1 | ue(v) |
| gfv_coordinate_z_present_flag | u(1) |
| if(gfv_coordinate_z_present_flag ) | |
| gfv_coordinate_z_max_value_minus1 | ue(v) |
| } | |
| for( i = 0; i <= gfv_num_kps_minus1; i++ ) { | |
| if( !gfv_kps_pred_flag ) { | |
| gfv_coordinate_x_abs[ i ] | ue(v) |
| if( gfv_coordinate_x_abs[ i ] > 0 ) | |
| gfv_coordinate_x_sign_flag[ i ] | u(1) |
| gfv_coordinate_y_abs[ i ] | ue(v) |
| if( gfv_coordinate_y_abs[ i ] > 0 ) | |
| gfv_coordinate_y_sign_flag[ i ] | u(1) |
| if( gfv_coordinate_z_present_flag > 0 ) { | |
| gfv_coordinate_z_abs[ i ] | ue(v) |
| if( gfv_coordinate_z_abs[ i ] > 0 ) | |
| gfv_coordinate_z_sign_flag[ i ] | u(1) |
| } | |
| } else { | |
| gfv_coordinate_dx_abs[ i ] | ue(v) |
| if( gfv_coordinate_dx_abs[ i ] > 0 ) | |
| gfv_coordinate_dx_sign_flag[ i ] | u(1) |
| gfv_coordinate_dy_abs[ i ] | ue(v) |
| if( gfv_coordinate_dy_abs[ i ] > 0 ) | |
| gfv_coordinate_dy_sign_flag[ i ] | u(1) |
| if( gfv_coordinate_z present_flag ) { | |
| gfv_coordinate_dz_abs[ i ] | ue(v) |
| if( gfv_coordinate_dz_abs[ i ] > 0 ) | |
| gfv_coordinate_dz_sign_flag[ i ] | u(1) |
| } | |
| } | |
| } | |
| } | |
| gfv_matrix_present_flag | u(1) |
| if(gfv_matrix_present_flag ) { | |
| if( !gfv_base_pic_flag ) | |
| gfv_matrix_pred_flag | u(1) |
| if( gfv_base_pic_flag \| \| !gfv_matrix pred_flag ) { | |
| gfv_matrix_element_precision_factor_minus1 | ue(v) |
| gfv_num_matrix_types_minus1 | ue(v) |
| for( i = 0; i <= num_matrix_types_minus1; i++ ) { | |
| gfv_matrix_type_idx[ i ] | u(6) |
| if( gfv_matrix_type_idx[ i ] = = 0 \| \| gfv_matrix_type_idx[ i ] = = 1 ) { | |
| if( gfv_coordinate_present_flag ) | |
| gfv_num_matrices_equal_to_num_kps_flag[ i ] | u(1) |
| if(!gfv_num_matrices_equal_to_num_kps_flag[ i ] ) | |
| gfv_num_matrices_info[ i ] | ue(v) |
| } else | |
| if( gfv_matrix_type_idx[ i ] = = 2 \| \| gfv_matrix_type_idx[ i ] = = 3 \| \| | |
| gfv_matrix_type_idx[ i ] >= 7 ) { | |
| if( gfv_matrix_type_idx[ i ] >= 7 ) | |
| gfv_num_matrices_minus1[ i ] | ue(v) |
| gfv_matrix_width_minus1[ i ] | ue(v) |
| gfv_matrix_height_minus1[ i ] | ue(v) |
| } else | |
| if( gfv_matrix_type_idx[ i ] >= 4 && gfv_matrix_type_idx[ i ] <= 6 && | |
| !gfv_coordinate_present_flag ) | |
| gfv_matrix_for_3D_space_flag[ i ] | u(1) |
| } | |
| } | |
| for( i = 0; i <= num_matrix_types_minus1; i++ ) { | |
| for( j = 0; j < numMatrices[ i ]; j++ ) | |
| for( k = 0; k < matrixHeight[ i ]; k++ ) | |
| for( m = 0; m <matrixWidth[ i ]; m++ ) { | |
| if( !gfv_matrix_pred_flag ) { | |
| gfv_matrix_element_int[ i ][ j ][ k ][ m ] | ue(v) |
| gfv_matrix_element_dec[ i ][ j ][ k ][ m ] | u(v) |
| if( gfv_matrix_element_int[ i][ j ][ k ][ m ] \| \| | |
| gfv_matrix_element_dec[ i ][ j ][ k ][ m ] ) | |
| gfv_matrix_element_sign_flag[ i ][ j ][ k ][ m ] | u(1) |
| } else { | |
| gfv_matrix_delta_element_int[ i ][ j ][ k ][ m ] | ue(v) |
| gfv_matrix_delta_element_dec[ i ][ j ][ k ][ m ] | ue(v) |
| if( gfv_matrix_delta_element_int[ i][ j ][ k ][ m ] \| \| | |
| gfv_matrix_delta_element_dec[ i ][ j ][ k ][ m ] ) | |
| gfv_matrix_delta_element_sign_flag[ i ][ j ][ k ][ m ] | u(1) |
| } | |
| } | |
| } | |
| } | |
| if( gfv_nn_present_flag ) | |
| if( gfv_nn_mode_idc = = 0 ) { | |
| while( !byte_aligned( ) ) | |
| gfv_nn_alignment_zero_bit_b | u(1) |
| for( i = 0; more_data_in_payload( ); i++ ) | |
| gfv_nn_payload_byte[ i ] | b(8) |
| } | |
| } | |

Table 2 is an example of a description related to a generative face video SEI message included in a bitstream.

```
The generative face video (GFV) SEI message carries facial parameters and indicates a
facial parameter translator network, denoted as TranslatorNN( ), that may be used to
convert various formats of facial parameters signalled in the SEI message into a particular
facial parameter format supported by the decoding system. A face picture generator neural
network, denoted as GenerativeNN( ), may be used to generate output pictures using the
facial parameters translated into the particular format and previously decoded output
pictures.
When a picture unit contains a GFV SEI message with a particular gfv_id value and
gfv_base_pic_flag equal to 1, the picture in the picture unit is referred to as a base picture
for that particular gfv_id value.
When a picture unit contains a GFV SEI message with a particular gfv_id value and
gfv_base_pic_flag equal to 0, and the picture unit does not contain a GFV SEI message
with that particular gfv_id value and gfv_base_pic_flag equal to 1, the picture in the
picture unit is referred to as a driving picture for that particular gfv_id value.
When a picture unit contains a GFV SEI message with a particular gfv_id value,
gfv_base_pic_flag equal to 0, and gfv_drive_pic_fusion_flag equal to 1, and the picture
unit does not contain a GFV SEI message with that particular gfv_id value and
gfv_base_pic_flag equal to 1, the picture in the picture unit is referred to as a fusion picture
for that particular gfv_id value.
NOTE 1 - Facial parameters could be determined from source pictures prior to
encoding.
NOTE 2 - Previously decoded output pictures input to GenerativeNN( ) may be a base
picture (a decoded output picture that provides the reference texture from which the
face pictures may be generated) and, optionally, a picture that can be fused by
GenerativeNN( ) to improve background texture and facial details. When the current
picture is not a base picture, the GFV SEI message may be used to generate a face
picture based on the previously decoded base picture, the facial parameters conveyed
by the GFV SEI message, and, optionally, the current decoded picture for fusion
purpose.
Use of this SEI message requires the definition of the following variables:
- Input and output picture width and height in units of luma samples, denoted herein by
CroppedWidth and CroppedHeight, respectively.
- Luma sample array baseCroppedYPic and chroma sample arrays baseCroppedCbPic
and baseCroppedCrPic for a decoded output picture, denoted as BasePicture,
corresponding to a source base picture.
- Luma sample array driveCroppedYPic and chroma sample arrays driveCroppedCbPic
and driveCroppedCrPic for a decoded output picture, denoted as DrivePicture,
corresponding to a source driving picture.
- Bit depth BitDepthy for the luma sample array of the input and output pictures.
- Bit depth BitDepthc for the chroma sample arrays, if any, of the input and output
pictures.
- A chroma format indicator, denoted herein by ChromaFormatIdc, as described in
subclause 7.3.
The variables Sub WidthC and SubHeightC are derived from ChromaFormatIdc as
specified by Table A.
gfv_id contains an identifying number that may be used to identify face feature
information and specify a neural network that may be used as TranslatorNN( ). The value
of gfv_id shall be in the range of 0 to 2³² − 2, inclusive. Values of gfv_id from 256 to 511,
inclusive, and from 2³¹ to 2³² − 2, inclusive, are reserved for future use by ITU-
T | ISO/IEC. Decoders conforming to this edition of this document encountering a GFV
SEI message with gfv_id in the range of 256 to 511, inclusive, or in the range of 2³¹
to 2³² − 2, inclusive, shall ignore the SEI message.
gfv_cnt specifies a GFV SEI message instance count value for this gfv_id value within a
picture unit.
The gfv_cnt of the first GFV SEI message, in decoding order, with a particular value of
gfv_id within a picture unit shall be equal to 0. When gfv_cnt assigned to currGfvCnt is
greater than 0, a GFV SEI message with the same gfv_id value and gfv_cnt equal to
currGfvCnt − 1 shall be present in the same picture unit and precede the current GFV SEI
message in decoding order.
The value of gfv_cnt shall be in the range of 0 to 65 535, inclusive.
gfv_base_pic_flag equal to 1 indicates that the current decoded output picture corresponds
to a base picture. gfv_base_pic_flag equal to 0 indicates that the current decoded output
picture does not correspond to a base picture or this SEI message does not specify syntax
elements for a base picture. When gfv_base_pic_flag is not present, it is inferred to be
equal to 0.
When a GFV SEI message is the first GFV SEI message, in decoding order, that has a
particular gfv_id value within the current CLVS, the value of gfv_base_pic_flag shall be
equal to 1.
When a GFV SEI message with a particular gfv_id value has gfv_base_pic_flag equal to 1,
the base picture for that particular gfv_id value, which is the current cropped decoded
picture, remains valid for the current decoded picture and all subsequent decoded pictures
of the current layer, in output order, until the end of the current CLVS or up to but
excluding the decoded picture that is within the current CLVS, follows the current decoded
picture in output order, and is associated with a GFV SEI message having that particular
gfv_id value and gfv_base_pic_flag equal to 1, whichever is earlier.
gfv_nn_present_flag equal to 1 indicates that a neural network that may be used as a
TranslatorNN( ) is contained or indicated by the SEI message. gfv_nn_present_flag equal
to 0 indicates that a neural network that may be used as a TranslatorNN( ) is not contained
or indicated by the SEI message. When gfv_nn_present_flag is not present, it is inferred to
be 0.
When gfv_nn_present_flag is equal to 0 and TranslatorNN is referenced in the semantics of
the GFV SEI message, the following constraint applies:
- If gfv_cnt is equal to 0, there shall be at least one GFV SEI message present in a
preceding picture unit in output order in the current CLVS and having the same value
of gfv_id as that in the current GFV SEI message and gfv_nn_present_flag equal to 1.
- Otherwise (gfv_cnt is greater than 0), there shall be at least one GFV SEI message that
is present in either the current picture unit or a preceding picture unit in output order in
the current CLVS and has the same value of gfv_id as that in the current GFV SEI
message and gfv_nn_present_flag equal to 1.
When gfv_nn_present_flag is equal to 0 and TranslatorNN is referenced in the semantics of
this SEI message, the following applies for deriving the applicable TranslatorNN:
- If gfv_cnt is greater than 0 and there exists one or more preceding GFV SEI messages
in decoding order in the current picture unit that has the same value of gfv_id as that in
the current GFV SEI message and gfv_nn_present_flag equal to 1, the applicable
TranslatorNN is defined by the last preceding GFV SEI message in decoding order in
the current picture unit that has the same value of gfv_id as that in the current GFV
SEI message and gfv_nn_present_flag equal to 1.
- Otherwise, the applicable TranslatorNN is defined by a GFV SEI message that is
present in the last preceding picture unit puB in output order in the current CLVS that
has the same value of gfv_id as the current GFV SEI message and gfv_nn_present_flag
equal to 1. When there are multiple such GFV SEI messages present in the picture unit
puB that have the same value of gfv_id as the current GFV SEI message and
gfv_nn_present_flag equal to 1, the applicable TranslatorNN is defined by the last of
such GFV SEI messages in decoding order.
gfv_nn_mode_idc, gfv_nn_alignment_zero_bit_a, gfv_nn_tag_uri, gfv_nn_uri,
gfv_nn_alignment_zero_bit_b, and gfv_nn_payload_byte[ i ] specify a neural network
that may be used as a TranslatorNN( ). gfv_nn_mode_idc, gfv_nn_alignment_zero_bit_a,
gfv_nn_tag_uri, gfv_nn_uri, gfv_nn_alignment_zero_bit_b, and gfv_nn_payload_byte[ i ]
have the same syntax and semantics as nnpfc_base_flag, nnpfc_mode_idc,
nnpfc_alignment_zero_bit_a, nnpfc_tag_uri, nnpfc_uri, nnpfc_alignment_zero_bit_b, and
nnpfc_payload_byte[ i ], respectively.
The GFV SEI messages that are present in the same picture unit and have the same values
of gfv_id and gfv_cnt shall have the same SEI payload content.
gfv_chroma_key_info_present_flag equal to 1 indicates that the syntax elements
gfv_chroma_key_value_present_flag[ c ] and gfv_chroma_key_thr_present_flag[ i ] are
present and the syntax elements and gfv_chroma_key_value[ c ] and
gfv_chroma_key_thr_value[ i ] might be present. gfv_chroma_key_info_present_flag equal
to 0 specifies that the syntax elements gfv_chroma_key_value_present_flag[ c ],
gfv_chroma_key_thr_present_flag[ i ], gfv_chroma_key_value[ c ], and
gfv_chroma_key_thr_value[ i ] are not present.
gfv_chroma_key_value_present_flag[ c ] equal to 1 indicates that the syntax element
gfv_chroma_key_value[ c ] is present. gfv_chroma_key_present_flag[ c ] equal to 0
indicates that the syntax element gfv_chroma_key_value[ c ] is not present.
The variable ChromaKeyDefaultValueFlag is set equal to !(
gfv_chroma_key_value_present_flag[ 0 ] || gfv_chroma_key_value_present_flag[ 1 ]
|| gfv_chroma_key_value_present_flag[ 2 ] ).
gfv_chroma_key_value[ c ] specifies the chroma key value corresponding to the c-th
colour component as follows:
- If ChromaKeyDefaultValueFlag is equal to 1, the variables GfvChromaKeyValue[ c ]
are specified as follows:
- GfvChromaKeyValue[ 0 ] is set equal to 50.
- GfvChromaKeyValue[ 1 ] is set equal to 220.
- GfvChromaKeyValue[ 2 ] is set equal to 100.
- Otherwise, ChromaKeyDefaultValueFlag is equal to 0, the following applies:
- If gfv_chroma_key_value_present_flag[ c ] is equal to 1, GfvChromaKeyValue[ c ]
is set equal to the value of gfv_chroma_key_value[ c ].
- Otherwise, gfv_chroma_key_value_present_flag[ c ] is equal to 0,
GfvChromaKeyValue[ c ] is not specified by this Specification.
gfv_chroma_key_thr_present_flag[ i ] equal to 1 indicates that the syntax element
gfv_chroma_thr_value[ i ] is present. gfv_chroma_key_thr_present_flag[ i ] equal to 0
indicates gfv_chroma_key_thr_value[ i ] is not present.
gfv_chroma_key_thr_value[ i ], when present, specifies the i-th chroma key threshold
value. The value of gfv_chroma_key_thr_value[ i ] shall be in the range of 0 to 255,
inclusive. When not present, the value of gfv_chroma_key_thr_value[ i ] is inferred as
follows:
If i is equal to 0, gfv_chroma_key_thr_value[ 0 ] is set equal to 48.
Otherwise, i is equal to 1, gfv_chroma_key_thr_value[ 1 ]is set equal to 75.
NOTE 3 - The syntax elements gfv_chroma_key_value_present[ c ],
gfv_chroma_key_value[ c ], and gfv_chroma_key_thr_value[ i ] could be used to
determine a transparency indicator for fusion of the generated face picture and
background picture. For example, a transparency indicator, denoted as alpha[ x ][ y ],
for picture sample value, denoted as I[ c ][ x ][ y ] with bitDepth[ c ], where
bitDepth[ 0 ] is equal to BitDepthy, bitDepth[ 1 ] and bitDepth[ 2 ] are equal to
BitDepth_{C}, and GfvChromaKey[ c ] values for sample coordinates x, y, and colour
components c could be determined as follows:
d[ x ][ y ]= 0
for(c = 0; c < 3; c++ )
  if( gfv_chroma_key_value_present[ c ] || ChromaKeyDefaultValueFlag )
    d[ x ][ y ] += ( I[ c ][ x ][ y ] / ( 1 << (bitDepth[ c ] − 8) ) −
GfvChromaKeyValue[ c ] )²
if( ( d[ x ][ y ] < gfv_chroma_key_thr_value[ 0 ] )
  alpha[ x ][ y ] = 0
else if ( ( d[ x ][ y ] > gfv_chroma_key_thr_value[ 1 ] )
  alpha[ x ][ y ] = 1
else
  alpha[ x ][ y ] = ( d[ x ][ y ] − gfv_chroma_key_thr_value[ 0 ] ) ÷
    ( gfv_chroma_key_thr_value[ 1 ] − gfv_chroma_key_thr_value[ 0 ] )
A value of alpha[ x ][ y ] equal to 0 could indicate transparency. A value of
alpha[ x ][ y ] equal to 1 could indicate opacity. Intermediate values of alpha[ x ][ y ]
could indicate semitransparency.
gfv_drive_pic_fusion_flag, when present, equal to 1 indicates that the current decoded
picture, which corresponds to a driving picture that may be used for fusion, may be input to
GenerativeNN( ). gfv_drive_pic_fusion_flag equal to 0 indicates that the current decoded
picture should not be input to GenerativeNN( ).
NOTE 4 - A gfv_drive_pic_fusion_flag value of 1 can be used, for example, to indicate
that the current decoded picture can be used to improve face details or handle
background changes.
NOTE 5 - When gfv_base_pic_flag is equal to 0 and gfv_drive_pic_fusion_flag is
equal to 1, the GFV process takes three inputs: the base picture, features from
keypoints and/or matrices carried in the GFV SEI message, and the current decoded
picture that is a fusion picture, and outputs a picture that is generated by the
GenerativeNN( ).
NOTE 6 - When gfv_base_pic_flag is equal to 0 and gfv_drive_pic_fusion_flag is
equal to 0, the GFV process takes twoinputs: the base picture and features from
keypoints and/or matrices carried in the GFV SEI message, and outputs a picture that is
generated by the GenerativeNN( ).
NOTE 7 - When gfv_base_pic_flag is equal to 1, the GFV process directly outputs the
cropped decoded picture.
When a GFV SEI message has gfv_base_pic_flag equal to 0 and
gfv_drive_pic_fusion_flag equal to 0, the GFV SEI message pertains to the current
decoded picture only.
When a GFV SEI message with a particular gfv_id value has gfv_base_pic_flag equal to 0
and gfv_drive_pic_fusion_flag equal to 1, the fusion picture for that particular gfv_id
value, which is the current cropped decoded picture, remains valid for the current decoded
picture and all subsequent decoded pictures of the current layer, in output order, until the
end of the current CLVS or up to but excluding the decoded picture that is within the
current CLVS, follows the current decoded picture in output order, and is associated with a
GFV SEI message having that particular gfv_id value, whichever is earlier.
When a GFV SEI message gfvSeiA with a particular gfv_id value has gfv_cnt greater than
0 and a GFV SEI message gfvSeiB with the same gfv_id value in the same picture unit has
gfv_base_pic_flag equal to 1 (i.e., the current decoded picture is a base picture), the GFV
SEI message gfvSeiA shall have gfv_drive_pic_fusion_flag equal to 0.
gfv_low_confidence_face_parameter_flag equal to 1 indicates the facial parameters have
been derived with low confidence. gfv_low_confidence_face_parameter_flag equal to 0
indicates the confidence information of the facial parameters is not specified.
gfv_coordinate_present_flag equal to 1 indicates that coordinate information of keypoints
is present. gfv_coordinate_present_flag equal to 0 indicates that coordinate information of
keypoints is not present.
It is a requirement of bitstream conformance that when gfv_matrix_type_idx[ i ] for any i
from 0 to gfv_num_matrix_types_minus1 is equal to 0 or 1, the value of
gfv_coordinate_present_flag shall be equal to 1.
gfv_kps_pred_flag equal to 1 indicates that the syntax elements
gfv_coordinate_dx_abs[ i ] ,gfv_coordinate_dy_abs[ i ], and gfv_coordinate_dz_abs[ i ] are
present and the syntax elements gfv_coordinate_dx_sign_flag[ i ],
gfv_coordinate_dy_sign_flag[ i ] and gfv_coordinate_dz_sign_flag[ i ] may be present.
gfv_kps_pred_flag equal to 0 indicates that the syntax elements gfv_coordinate_x_abs[ i ],
gfv_coordinate_y_abs[ i ], and gfv_coordinate_z_abs[ i ] are present and the syntax
elements gfv_coordinate_x_sign_flag[ i ], gfv_coordinate_y_sign_flag[ i ] and
gfv_coordinate_z_sign_flag[ i ] may be present.
When gfv_coordinate_present_flag is equal to 1, gfv_base_pic_flag is equal to 0, and
gfv_kps_pred_flag is equal to 1, there shall be a previous GFV SEI message in decoding
order with the same gfv_id as the current GFV SEI message and gfv_base_pic_flag equal
to 1 in the current CLVS.
gfv_coordinate_precision_factor_minus1 plus 1 indicates the precision of key point
coordinates signgalled in the SEI message. The value of
gfv_coordinate_precision_factor_minus1 shall be in the range of 0 to 31, inclusive. When
gfv_coordinate_present_flag is equal to 1, gfv_base_pic_flag is equal to 0, and
gfv_kps_pred_flag is equal to 1, the value of gfv_coordinate_precision_factor_minus1 is
inferred to be equal to the gfv_coordinate_precision_factor_minus1 of the previous GFV
SEI message in decoding order with the same gfv_id as the current GFV SEI message and
gfv_base_pic_flag equal to 1.
gfv_num_kps_minus1 plus 1 indicates the number of keypoints. The value of
gfv_num_kps_minus1 shall be in the range of 0 to 2¹⁰ − 1, inclusive. When
gfv_coordinate_present_flag is equal to 1, gfv_base_pic_flag is equal to 0, and
gfv_kps_pred_flag is equal to 1, the value of gfv_num_kps_minus1 is inferred to be equal
to the gfv_num_kps_minus1 of the previous GFV SEI message in decoding order with the
same gfv_id as the current GFV SEI message and gfv_base_pic_flag equal to 1.
gfv_coordinate_z_present_flag equal to 1 indicates that z-axis coordinate information of
the keypoints is present. gfv_coordinate_z_present_flag equal to 0 indicates that the z-axis
coordinate information of the keypoints is not present. When gfv_coordinate_present_flag
is equal to 1, gfv_base_pic_flag is equal to 0, and gfv_kps_pred_flag is equal to 1, the
value of coordinate_z_present_flag is inferred to be equal to the coordinate_z_present_flag
of the previous GFV SEI message in decoding order with the same gfv_id as the current
GFV SEI message and gfv_base_pic_flag equal to 1.
gfv_coordinate_z_max_value_minus1 plus 1 indicates the maximum absolute value of z-
axis coordinates of keypoints. The value of gfv_coordinate_z_max_value_minus1 shall be
in the range of 0 to 2¹⁶ − 1, inclusive. When gfv_coordinate_present_flag is equal to 1,
gfv_base_pic_flag is equal to 0, and gfv_kps_pred_flag is equal to 1, the value of
gfv_coordinate_z_max_value_minus1 is inferred to be equal to the
gfv_coordinate_z_max_value_minus1, when present, in the previous GFV SEI message in
decoding order with the same gfv_id as the current GFV SEI message and
gfv_base_pic_flag equal to 1.
gfv_coordinate_x_abs[ i ] is used to derive the x-axis coordinate of the i-th keypoint. The
value of gfv_coordinate_x_abs[ i ] shall be in the range of 0 to
2^{gfv}^{_{—}}^{coordinate}^{_{—}}^{precision}^{_{—}}^{factor}^{_{—}}^{minus1 + 1}, inclusive
gfv_coordinate_x_sign_flag[ i ] specifies the sign of the x-axis coordinate of the i-th
keypoint. When gfv_coordinate_x_sign_flag[ i ] is not present, it is inferred to be equal to
0.
gfv_coordinate_y_abs[ i ] is used to derive y-axis coordinate of i-th keypoint. The value
of gfv_coordinate_y_abs[ i ] shall be in the range of 0 to 2^{gfv}^{_{—}}^{coordinate}^{_{—}}^{precision}^{_{—}}^{factor}^{_{—}}^{minus1 + 1},
inclusive.
gfv_coordinate_y_sign_flag[ i ] specifies the sign of the y-axis coordinate of the i-th
keypoint. When gfv_coordinate_y_sign_flag[i] is not present, it is inferred to be equal to 0.
gfv_coordinate_z_abs[ i ] is used to derive z-axis coordinate of the i-th keypoint. The
value of gfv_coordinate_z_abs[ i ] shall be in the range of 0 to
2^{gfv}^{_{—}}^{coordinate}^{_{—}}^{precision}^{_{—}}^{factor}^{_{—}}^{minus1 + 1}, inclusive.
gfv_coordinate_z_sign_flag[ i ] specifies the sign of the z-axis coordinate of the i-th key
point. When gfv_coordinate_z_sign_flag[ i ] is not present, it is inferred to be equal to 0.
gfv_coordinate_dx_abs[ i ] specifies a difference value that is used to derive x-axis
coordinate of the i-th keypoint. The value of gfv_coordinate_dx_abs[ i ] shall be in the
range of 0 to 2^{gfv}^{_{—}}^{coordinate}^{_{—}}^{precision}^{_{—}}^{factor}^{_{—}}^{minus1 + 2}, inclusive.
gfv_coordinate_dx_sign_flag[ i ] specifies the sign of the difference value of the x-axis
coordinate of the i-th keypoint. When gfv_coordinate_dx_sign_flag[ i ] is not present, it is
inferred to be equal to 0.
gfv_coordinate_dy_abs[ i ] specifies a difference value that is used to derive y-axis
coordinate of the i-th keypoint. The value of gfv_coordinate_dy_abs[ i ] shall be in the
range of 0 to 2^{gfv}^{_{—}}^{coordinate}^{_{—}}^{precision}^{_{—}}^{factor}^{_{—}}^{minus1 + 2}, inclusive.
gfv_coordinate_dy_sign_flag[ i ] specifies the sign of the difference value of the y-axis
coordinate of the i-th keypoint. When gfv_coordinate_yd_sign_flag[i] is not present, it is
inferred to be equal to 0.
gfv_coordinate_dz_abs[ i ] specifies a difference value that is used to derive z-axis
coordinate of the i-th keypoint. The value of gfv_coordinate_dz_abs[ i ] shall be in the
range of 0 to 2^{gfv}^{_{—}}^{coordinate}^{_{—}}^{precision}^{_{—}}^{factor}^{_{—}}^{minus1 + 2}, inclusive.
gfv_coordinate_dz_sign_flag[ i ] specifies the sign of the difference value of the z-axis
coordinate of the i-th key point. When gfv_coordinate_dz_sign_flag[ i ] is not present, it is
inferred to be equal to 0.
If gfv_coordinate_z_max_value_minus1 is present, the variable CroppedDepth is set equal
to gfv_coordinate_z_max_value_minus1 + 1. Otherwise, CroppedDepth is set equal to 0.
When gfv_kps_pred_flag is equal to 1, the variables coordinateDeltaX[ i ],
coordinateDeltaY[ i ] and coordinateDeltaZ[ i ] indicating the delta x-axis coordinate, delta
y-axis coordinate and delta z-axis coordinate of the i-th keypoint, respectively, are derived
as follows:
    coordinateDeltaX[ i ] = ( 1 − 2 * gfv_coordinate_dx_sign_flag[ i ] ) *
    gfv_coordinate_dx_abs[ i ] ÷
        ( 1 << ( gfv_coordinate_precision_factor_minus1 + 1 ) )
    coordinateDeltaY[ i ] = ( 1 − 2 * gfv_coordinate_dy_sign_flag[ i ] ) *
    gfv_coordinate_dy_abs[ i ] ÷
        ( 1 << ( gfv_coordinate_precision_factor_minus1 + 1 ) )
    if( gfv_coordinate_z_present_flag )
      coordinateDeltaZ[ i ] = ( 1 − 2 * gfv_coordinate_dz_sign_flag[ i ] ) *
    gfv_coordinate_dz_abs[ i ] ÷
        ( 1 << ( gfv_coordinate_precision_factor_minus1 + 1 ) )
The variables coordinateX[ i ], coordinateY[ i ], and, when gfv_coordinate_z_present_flag
is equal to 1, coordinateZ[ i ] indicating the x-axis coordinate, y-axis coordinate and z-axis
coordinate of the i-th keypoint, respectively, are derived as follows:
  If gfv_kps_pred_flag is equal to 0, the following applies:
    coordinateX[ i ] = ( 1 − 2 * gfv_coordinate_x_sign_flag[ i ] ) *
    gfv_coordinate_x_abs[ i ] ÷
        ( 1 << ( gfv_coordinate_precision_factor_minus1 + 1 ) )
    coordinateY[ i ] = ( 1 − 2 * gfv_coordinate_y_sign_flag[ i ] ) *
    gfv_coordinate_y_abs[ i ] ÷
        ( 1 << ( gfv_coordinate_precision_factor_minus1 + 1 ) )
    if (gfv_coordinate_z_present_flag )
        coordinateZ[ i ] = ( 1 − 2 * gfv_coordinate_z_sign_flag[ i ] ) *
    gfv_coordinate_z_abs[ i ] ÷
        ( 1 << ( gfv_coordinate_precision_factor_minus1 + 1 ) )
  Otherwise (gfv_kps_pred_flag is equal to 1), the following applies:
    if( gfv_base_pic_flag ) {
      coordinateX[ i ] = (( i > 0) ? coordinateX[ i − 1 ] : 0 ) + coordinateDeltaX[ i ]
      coordinateY[ i ] = (( i > 0 ) ? coordinateY[ i − 1 ] : 0 ) + coordinateDeltaY[ i ]
      if (gfv_coordinate_z_present_flag )
        coordinateZ[ i ] = (( i > 0 ) ? coordinateZ[ i − 1 ] : 0 ) + coordinateDeltaZ[ i ]
    } else if( gfv_cnt = = 0 ) {
      coordinateX[ i ] = BaseKpCoordinateX[ i ] + coordinateDeltaX[ i ]
      coordinateY[ i ] = BaseKpCoordinateY[ i ] + coordinateDeltaY[ i ]
      if (gfv_coordinate_z_present_flag )
        coordinateZ[ i ] = BaseKpCoordinateZ[ i ] + coordinateDeltaZ[ i ]
    } else {
      coordinateX[ i ] = PrevKpCoordinateX[ i ] + coordinateDeltaX[ i ]
      coordinateY[ i ] = PrevKpCoordinateY[ i ] + coordinateDeltaY[ i ]
      coordinateZ[ i ] = PrevKpCoordinateZ[ i ] + coordinateDeltaZ[ i ]
    }
The following applies for derivation of the variables BaseKpCoordinateX[ i ],
BaseKpCoordinateY[ i ], BaseKpCoordinateZ[ i ], PrevKpCoordinateX[ i ],
PrevKpCoordinateY[ i ], and PrevKpCoordinateZ[ i ]:
    if( gfv_base_pic_flag ) {
      PrevKpCoordinateX[ i ] = BaseKpCoordinateX[ i ] = coordinateX[ i ]
      PrevKpCoordinateY[ i ] = BaseKpCoordinateY[ i ] = coordinateY[ i ]
      if (gfv_coordinate_z_present_flag )
        PrevKpCoordinateZ[ i ] = BaseKpCoordinateZ[ i ] = coordinateZ[ i ]
    } else {
      PrevKpCoordinateX[ i ] = coordinateX[ i ]
      PrevKpCoordinateY[ i ] = coordinateY[ i ]
      PrevKpCoordinateZ[ i ] = coordinateZ[ i ]
    }
gfv_matrix_present_flag equal to 1 indicates that matrix parameters are present.
gfv_matrix_present_flag equal to 0 indicates that matrix parameters are not present. When
gfv_coordinate_present_flag is equal to 0, gfv_matrix_present_flag shall be equal to 1.
gfv_matrix_pred_flag equal to 0 indicates that the syntax elements
gfv_matrix_element_int[ i ][ j ][ k ][ m ] and gfv_matrix_element_dec[ i ][ j ][ k ][ m ] are
present and the syntax element gfv_matrix_element_sign_flag[ i ][ j ][ k ][ m ] may be
present. gfv_matrix_pred_flag equal to 1 indicates that the syntax elements
gfv_matrix_delta_element_int[ i ][ j ][ k ][ m ] and
gfv_matrix_delta_element_dec[ i ][ j ][ k ][ m ] are present and the syntax element
gfv_matrix_delta_element_sign_flag [ i ][ j ][ k ][ m ] may be present. When
gfv_matrix_pred_flag is not present, it is inferred to be 0.
When gfv_matrix_present_flag is equal to 1, gfv_base_pic_flag is equal to 0, and
gfv_matrix_pred_flag is equal to 1, there shall be a previous GFV SEI message in
decoding order with the same gfv_id as the current GFV SEI message and
gfv_base_pic_flag equal to 1 in the current CLVS.
gfv_matrix_element_precision_factor_minus1 plus 1 indicates the precision of matrix
elements signalled in the SEI message. The value of
gfv_matrix_element_precision_factor_minus1 shall be in the range of 0 to 31, inclusive.
When gfv_matrix_present_flag is equal to 1, gfv_base_pic_flag is equal to 0, and
gfv_matrix_pred_flag is equal to 1, the value of
gfv_matrix_element_precision_factor_minus1 is inferred to be equal to the
gfv_matrix_element_precision_factor_minus1 of the previous GFV SEI message in
decoding order with the same gfv_id as the current GFV SEI message and
gfv_base_pic_flag equal to 1.
gfv_num_matrix_types_minus1 plus 1 indicates the number of matrix types signalled in
the SEI message. The value of gfv_num_matrix_types_minus1 shall be in the range of 0 to
2⁶ − 1, inclusive. It is a requirement of bitstream conformance that when
gfv_matrix_pred_flag is equal to 1 and gfv_base_pic_flag is equal to 0, the value of
gfv_num_matrix_types_minus1 shall be equal to the value of
gfv_num_matrix_types_minus1 in each of the preceding GFV SEI message in decoding
order in the current CLVS which has the same gfv_id value as the gfv_id value in the
current SEI and has gfv_base_pic_flag equal to 1. When gfv_matrix_present_flag is equal
to 1, gfv_base_pic_flag is equal to 0, and gfv_matrix_pred_flag is equal to 1, the value of
gfv_num_matrix_types_minus1 is inferred to be equal to the
gfv_num_matrix_types_minus1 of the previous GFV SEI message in decoding order with
the same gfv_id as the current GFV SEI message and gfv_base_pic_flag equal to 1.
gfv_matrix_type_idx[ i ] indicates the index of the i-th matrix type as specified in Table
A. The value of gfv_matrix_type_idx[ i ] shall be in the range of 0 to 63, inclusive. In
bitstreams conforming to this version of this Specification, the value of
gfv_matrix_type_idx[ i ] shall be in the range of 0 to 31, inclusive. Decoders conforming to
this version of this Specification shall allow gfv_matrix_type_idx[ i ] to be greater than 31
to appear in the bitstream and the decoder shall ignore all information for the i-th type of
matrix for which gfv_matrix_type_idx[ i ] is greater than 31.
```

Table A - Specification of gfv_matrix_type_idx[ i ]

| Value | Specification |
|---|---|
| 0 | Affine translation matrix with the size of 2*2 or 3*3. |
| 1 | Covariance matrix with size of 2*2 or 3*3. |
| 2 | Mouth matrix representing mouth motion. |
| 3 | Eye matrix representing the open-close status and level of eyes. |
| 4 | Head rotation paramters with the size of 2*2 or 3*3 representing the head |
| | rotation in 2D space or 3D space. |
| 5 | Head translation matrix with the size of 1*2 or 1*3 representing head |
| | translationin 2D space or 3D space. |
| 6 | Head location matrix with size of 1*2 or 1*3 representing the head location |
| | in 2D space or 3D space. |
| 7 | Compact matrix with the size being specified by |
| | gfv_matrix_width_minus1[i] and gfv_matrix_height_minus1[i]. |
| 8...31 | Other matrix that may be used as determined by the application with the size |
| | being specified by gfv_matrix_width_minus1[i] and |
| | gfv_matrix_height_minus1[i]. |
| 32...63 | Reserved |

```
NOTE 8 - The undefined matrxi type is used to represent the matrxi type rather than
affine translation matrix, covariance matrix, rotation matrix, translation matrix and
compact feature matrix. It can be used by the user to extend the matrix type.
gfv_num_matrices_equal_to_num_kps_flag[ i ] equal to 1 indicates that the number of
matrices of the i-th matrix type is equal to gfv_num_kps_minus1 + 1.
gfv_num_matrices_equal_to_num_kps_flag[ i ] equal to 0 indicates the number of matrices
of the i-th matrix type is not equal to gfv_num_kps_minus1 + 1. If gfv_matrix_present_flag
is equal to 1, gfv_base_pic_flag is equal to 0, gfv_matrix_pred_flag is equal to 1,
gfv_matrix_type_idx[ i ] is equal to 0 or 1, and gfv_coordinate_present_flag is equal to 1,
the value of gfv_num_matrices_equal_to_num_kps_flag[ i ] is inferred to be equal to the
gfv_num_matrices_equal_to_num_kps_flag[ i ], when present, in the previous GFV SEI
message in decoding order with the same gfv_id as the current GFV SEI message and
gfv_base_pic_flag equal to 1. Otherwise, when
gfv_num_matrices_equal_to_num_kps_flag[ i ] is not present, its vlaue is inferred to be
equal to 0.
gfv_num_matrices_info[ i ] provides information to derive the number of the matrices of
the i-th matrix type. The value of gfv_num_matrices_info[ i ] shall be in the range of 0 to
2¹⁰ − 1, inclusive. When gfv_matrix_present_flag is equal to 1, gfv_base_pic_flag is equal
to 0, gfv_matrix_pred_flag is equal to 1, gfv_matrix_type_idx[ i ] is equal to 0 or 1, and
either gfv_coordinate_present_flag is equal to 0 or
gfv_num_matrix_equal_to_num_kps_flag[ i] is equal to 0, the value of
gfv_num_matrices_info[ i ] is inferred to be equal to the gfv_num_matrices_info[ i ], when
present, in the previous GFV SEI message in decoding order with the same gfv_id as the
current GFV SEI message and gfv_base_pic_flag equal to 1.
gfv_matrix_width_minus1[ i ] plus 1 indicates the width of the matrix of the i-th matrix
type. The value of gfv_matrix_width_minus1[ i ] shall be in the range of 0 to 2¹⁰ − 1,
inclusive. When gfv_matrix_present_flag is equal to 1, gfv_matrix_pred_flag is equal to 0,
gfv_matrix_pred_flag is equal to 1, and gfv_matrix_type_idx[ i ] is equal to 2 or 3 or is
greater than or equal to 7, the value of gfv_matrix_width_minus1[ i ] is inferred to be equal
to the gfv_matrix_width_minus1[ i ], when present, in the previous GFV SEI message in
decoding order with the same gfv_id as the current GFV SEI message and gfv_base_pic_flag
equal to 1.
gfv_matrix_height_minus1[ i ] plus 1 indicates the height of the matrix of the i-th matrix
type. The value of gfv_matrix_height_minus1[ i ] shall be in the range of 0 to 2¹⁰ − 1,
inclusive. When gfv_matrix_present_flag is equal to 1, gfv_base_pic_flag is equal to 0,
gfv_matrix_pred_flag is equal to 1, and gfv_matrix_type_idx[ i ] is equal to 2 or 3 or is
greater than or equal to 7, the value of gfv_matrix_height_minus1[ i ] is inferred to be equal
to the gfv_matrix_height_minus1[ i ], when present, in the previous GFV SEI message in
decoding order with the same gfv_id as the current GFV SEI message and gfv_base_pic_flag
equal to 1.
gfv_matrix_for_3D_space_flag[ i ] equal to 1 indicates the matrix of the i-th matrix type is
a matrix defined in three-dimensional space. gfv_matrix_for_3D_space_flag[ i ] equal to 0
indicates the matrix of the i-th matrix type is a matrix defined in two-dimensional space.
When gfv_matrix_present_flag is equal to 1, gfv_base_pic_flag is equal to 0,
gfv_matrix_pred_flag is equal to 1, gfv_matrix_type_idx[ i ] is equal to 4, 5, or 6, and
gfv_coordinate_present_flag is equal to 0, the value of gfv_matrix_for_3D_space_flag[ i ]
is inferred to be equal to the gfv_matrix_for_3D_space_flag[ i ], when present, in the
previous GFV SEI message in decoding order with the same gfv_id as the current GFV SEI
message and gfv_base_pic_flag equal to 1.
When gfv_matrix_width_minus1[ i ] is not present, it is inferred as follows:
- If gfv_matrix_type_idx[ i ] is equal to 0, 1 or 4, and one of coordinate_z_present_flag
and gfv_matrix_for_3D_space_flag[ i ] is present and equal to 1.
gfv_matrix_width_minus1[i] is inferred to be equal to 2.
- Otherwise, if gfv_matrix_type_idx[ i ] is equal to 0, 1 or 4, and one of
coordinate_z_present_flag and gfv_matrix_for_3D_space_flag[ i ] is present and equal
to 0, gfv_matrix_width_minus1[ i ] is inferred to be equal to 1.
- Otherwise (gfv_matrix_type_idx[ i ]is equal to 5 or 6), gfv_matrix_width_minus1[ i ]is
inferred to be equal to 0.
When gfv_matrix_height_minus1[ i ] is not present, it is inferred as follows:
- If gfv_matrix_type_idx is equal to 0, 1, 4, 5 or 6, and one of
gfv_coordinate_z_present_flag and gfv_matrix_for_3D_space_flag[ i ] is present and
equal to 1, gfv_matrix_height_minus1[ i ] is inferred to be equal to 2.
- Otherwise (gfv_matrix_type_idx is equal to 0, 1, 4, 5 or 6, and one of
gfv_coordinate_z_present_flag and gfv_matrix_for_3D_space_flag[ i ] is 0),
gfv_matrix_height_minus1[ i ] is inferred to be equal to 1.
The variables matrix Width[ i ] and matrixHeight[ i ] indicating the width and height of the
matrix of the i-th matrix type are derived as follows:
if( gfv_matrix_pred_flag ) {
  matrixWidth[ i ] = BaseMatrixWidth[ i ]
  matrixHeight[ i ] = BaseMatrixHeight[ i ]
} else {
  matrixWidth[ i ] = gfv_matrix_width_minus1[ i ] + 1
  matrixHeight[ i ] = gfv_matrix_height_minus1[ i ] + 1
}
if( gfv_base_pic_flag ) {
  BaseMatrixWidth[ i ] = matrixWidth[ i ]
  BaseMatrixHeight[ i ] = matrixHeight[ i ]
}
gfv_num_matrices_minus1[ i ] plus 1 indicates the number of matrices of the i-th matrix
type. The value of gfv_num_matrices_minus1[ i ] shall be in the range of 0 to 2¹⁰ − 1,
inclusive. When gfv_matrix_present_flag is equal to 1, gfv_base_pic_flag is equal to 0,
gfv_matrix_pred_flag is equal to 1, and gfv_matrix_type_idx[ i ] is greater than or equal to
7, the value of gfv_num_matrices_minus1[ i ] is inferred to be equal to the
gfv_num_matrices_minus1[ i ], when present, in the previous GFV SEI message in decoding
order with the same gfv_id as the current GFV SEI message and gfv_base_pic_flag equal to
1.
The variable numMatrices[ i ] indicating the number of the matrices of the i-th matrix type
is derived as follows:
if( gfv_matrix_pred_flag )
  numMatrices[ i ] = BaseNumMatrices[ i ]
else if( gfv_matrix_type_idx[ i ] = = 0 || gfv_matrix_type_idx[ i ] = = 1 ) {
  if( gfv_coordinate_present_flag )
    numMatrices[ i ] = gfv_num_matrices_equal_to_num_kps_flag[ i ] ?
gfv_num_kps_minus1 + 1:
      ( gfv_num_matrices_info[ i ] < gfv_num_kps_minus1 ? gfv_num_matrices_info
[ i ] + 1:
      gfv_num_matrices_info [ i ] + 2 )
  else
    numMatrices[ i ] = gfv_num_matrices_info[ i ] + 1
} else if( gfv_matrix_type_idx[ i ] >= 2 && gfv_matrix_type_idx[ i ] < 7 )
  numMatrices[ i ] = 1
else
  numMatrices[ i ] = gfv_num_matrices_minus1[ i ] + 1
if( gfv_base_pic_flag )
  BaseNumMatrices[ i ] = numMatrices[ i ]
It is a requirement of bitstream conformance that when gfv_matrix_pred_flag is equal to 1
and gfv_base_pic_flag is equal to 0, the values of numMatrices[ i ], matrixWidth[ i ], and
matrixHeight[ i ] for i in the range of 0 to gfv_num_matrix_types_minus1, inclusive shall be
respectively equal to the values of numMatrices[ i ], matrix Width[ i ], and matrixHeight[ i ]
for i in the range of 0 to gfv_num_matrix_types_minus1, inclusive in each of the preceding
GFV SEI message in decoding order in the current CLVS which has the same gfv_id value
as the gfv_id value in the current SEI and has gfv_base_pic_flag equal to 1.
gfv_matrix_element_int[ i ][ j ][ k ][ m ] indicates the integer part of the value of the matrix
element at position (m, k) of the j-th matrix of the i-th matrix type. The value of
gfv_matrix_element_int[ i ][ j ][ k ][ m ] shall be in the range of 0 to 2³² − 2, inclusive.
gfv_matrix_element_dec[ i ][ j ][ k ][ m ] indicates the decimal part of the value of the
matrix element at position (m, k) of the j-th matrix of the i-th matrix type. The length of
gfv_matrix_element_dec[ i ][ j ][ k ][ m ] is
gfv_matrix_element_precision_factor_minus1 + 1 bits.
gfv_matrix_element_sign_flag[ i ][ j ][ k ][ m ] indicates the sign of the matrix element at
position (m, k) of the j-th matrix of the i-th matrix type. When
gfv_matrix_element_sign_flag[ i ][ j ][ k ][ m ]is not present, it is inferred to be equal to 0.
gfv_matrix_delta_element_int[ i ][ j ][ k ][ m ] indicates the integer part of the difference
value of the matrix element at position (m, k) of the j-th matrix of the i-th matrix type. The
value of gfv_matrix_delta_element_int[ i ][ j ][ k ][ m ] shall be in the range of 0 to 2³² − 2,
inclusive.
gfv_matrix_delta_element_dec[ i ][ j ][ k ][ m ] indicates the decimal part of the difference
value of the matrix element at position (m, k) of the j-th matrix of the i-th matrix type. The
value of gfv_matrix_delta_element_dec[ i ][ j ][ k ][ m ] shall be in the range of 0 to 2³² − 2,
inclusive.
gfv_matrix_delta_element_sign_flag[ i ][ j ][ k ][ m ] indicates the sign of the difference
value of the matrix element at position (m, k) of the j-th matrix of the i-th matrix type. When
gfv_matrix_delta_element_sign_flag[ i ][ j ][ k ][ m ]is not present, it is inferred to be equal
to 0.
When gfv_matrix_pred_flag is equal to 1, the variable
matrixElementDeltaVal[ i ][ j][ k ][ m ] representing the difference value of the matrix
element at position (m, k) of the j-th matrix of the i-th matrix type is derived as follows:
    matrixElementDeltaVal[ i][ j ][ k ][ m ] = (1-2 *
    gfv_matrix_delta_element_sign_flag[ i ][ j ][ k ][ m ]) *
    (gfv_matrix_delta_element_int[ i ][ j ][ k ][ m ] +
    (gfv_matrix_delta_element_dec[ i ][ j ][ k ][ m ] ÷
    (1<<gfv_matrix_element_precision_factor_minus1+1))
    The variable matrixElementVal[ i ][ j][ k ][ m ] representing the value of the matrix
    element at position (m, k) of the j-th matrix of the i-th matrix type is derived as follows:
  If gfv_matrix_pred_flag is equal to 0, the following applies:
    matrixElementVal[ i ][ j ][ k ][ m ] = (1-2 *
    gfv_matrix_element_sign_flag[ i ][ k ][ m ]) *
    (gfv_matrix_element_int[ i ][ j ][ k ][ m ] + (gfv_matrix_element_dec[ i ][ j ][ k ][ m ] ÷
    (1<< gfv_matrix_element_precision_factor_minus1+1))
    if( gfv_base_pic_flag )
        BaseMatrixElementVal[ i][ j ][ k ][ m ] = matrixElementVal[ i][ j ][ k ][ m ]
  Otherwise (gfv_matrix_pred_flag is equal to 1), the following applies:
    if( gfv_cnt = = 0 )
        matrixElementVal[ i][ j ][ k ][ m ] = BaseMatrixElementVal[ i][ j ][ k ][ m ] +
            matrixElementDeltaVal[ i][ j ][ k ][ m ]
    else
        matrixElementVal[ i][ j ][ k ][ m ] = PrevMatrixElementVal[ i][ j ][ k ][ m ] +
            matrixElementDeltaVal[ i][ j ][ k ][ m ]
  The following applies:
    if( gfv_base_pic_flag )
        PrevMatrixElementVal[ i][ j ][ k ][ m ] = BaseMatrixElementVal[ i][ j ][ k ][ m ] =
            matrixElementVal[ i][ j ][ k ][ m ]
    else
        PrevMatrixElementVal[ i][ j ][ k ][ m ] = matrixElementVal[ i][ j ][ k ][ m ]
For a particular gfv_id value, the following process is used in increasing order of gfv_cnt to
generate a video picture per each GFV SEI message that has gfv_base_pic_flag equal to 0
and a unique value of gfv_cnt within a picture unit:
    DeriveSigParam( )
    TranslatorNN( sigKeyPoint, sigMatrix )
    DeriveInputTensors( )
    if( gfv_base_pic_flag = = 0 && gfv_drive_pic_fusion_flag = = 0 ) {
        if( ChromaFormatIdc = = 0)
          GenerativeNN( inputBaseY, inputBaseKeyPoint, inputBaseMatrix,
    inputDriveKeyPoint,
              inputDriveMatrix, CroppedWidth, CroppedHeight, CroppedDepth )
        else
          GenerativeNN( inputBaseY, inputBaseCb, inputBaseCr, inputBaseKeyPoint,
    inputBaseMatrix,
              inputDriveKeyPoint, inputDriveMatrix, CroppedWidth, CroppedHeight,
    CroppedDepth )
    } else if( gfv_base_pic_flag = = 0 && gfv_drive_pic_fusion_flag = = 1 ) {
        if( ChromaFormatIdc = = 0)
          GenerativeNN( inputBaseY, inputDriveY, inputBaseKeyPoint, inputBaseMatrix,
    inputDriveKeyPoint,
              inputDriveMatrix, CroppedWidth, CroppedHeight, CroppedDepth )
        else
          GenerativeNN( inputBaseY, inputBaseCb, inputBaseCr, inputDriveY, inputDriveCb,
    inputDriveCr,
              inputBaseKeyPoint, inputBaseMatrix,, inputDriveKeyPoint, inputDriveMatrix,
              CroppedWidth, CroppedHeight, CroppedDepth )
    }
    StoreOutputTensors( )
The process DeriveSigParam( ) for deriving the inputs of TranslatorNN( ) is specified as
follows:
  The keypoint coordinate array sigKeyPoint and the matrix sigMatrix are derived as
  follows:
    if( gfv_coordinate_present_flag )
        for( i = 0; i <= gfv_num_kps_minus1; i++ ) {
          sigKeyPoint[ i ][ 0 ] = coordinateX[ i ]
          sigKeyPoint[ i ][ 1 ] = coordinate Y[ i ]
          if( gfv_coordinate_z_present_flag )
            sigKeyPoint[ i ][ 2 ] = coordinateZ[ i ]
        }
    else
        for( i = 0; i <= gfv_num_kps_minus1; i++ ) {
          sigKeyPoint[ i ][ 0 ] = 0
          sigKeyPoint[ i ][ 1 ] = 0
          if ( gfv_coordinate_z_present_flag )
            sigKeyPoint[ i ][ 2 ] = 0
        }
    if( gfv_matrix_present_flag )
        for ( i = 0; i <= gfv_num_matrix_types_minus1; i++ )
          for ( j = 0; j < numMatrices[ i ]; j++ )
            for( k = 0; k < matrixHeight [ i ]; k++ )
              for( l = 0;l < matrixWidth [ i ]; l++)
                sigMatrix[ i ][ j ][ k ][ l ] = matrixElementVal[ i ][ j][ k][ l ]
    else
        for( i = 0; i <= gfv_num_matrix_types_minus1; i++ )
          for ( j = 0; j < numMatrices[ i ]; j++ )
            for( k = 0; k < matrixHeight [ i ]; k++ )
              for( l = 0;l < matrixWidth [ i ]; l++)
                sigMatrix[ i ][ j ][ k ][ l ] = 0
TranslatorNN( ) is a process to translate the various formats of the facial parameters carried
in the SEI message to the fixed format of the facial parameters to be input to the generative
network to generate the output picture
Inputs to TranslatorNN( ) are:
- sigKeyPoint and sigMatrix
Outputs of TranslatorNN( ) are:
- convKeyPoint and convNumKeyPoint
- convMatrix and convNumMatrix, convMatrixWidth, convMatrixHeight
The process DeriveInputTensors( ) for deriving the inputs of GenerativeNN( ) is specified as
follows:
When gfv_base_pic_flag is equal to 1, the BasePicture input tensor inputBaseY,
inputBaseCb and inputBaseCr are derived as follows:
  for( x = 0; x < CroppedWidth; x++ )
    for ( y = 0; y < CroppedHeight; y++ )
      inputBaseY[ x ][ y ] = InpY( baseCroppedYPic[ x ][ y ] )
  if( ChromaFormatIdc != 0 )
    for( x = 0; x < CroppedWidth / Sub WidthC; x++ )
      for ( y =0; y < CroppedHeight / SubHeightC; y++ ) {
        inputBaseCb[ x][ y ] = InpC( baseCroppedCbPic[ x][ y ] )
        inputBaseCr[ x][ y ] = InpC( baseCroppedCrPic[ x ][ y ] )
      }
When gfv_base_pic_flag is equal to 0 and gfv_drive_pic_fusion_flag is equal to 1, the
DrivePicture luma sample array inputDriveY, inputDriveCb and input DriveCr are derived
as follows:
  for( x = 0; x< CroppedWidth; x++ )
    for ( y = 0; y< CroppedHeight; y++ )
      inputDriveY[ x ][ y ] = InpY( driveCroppedYPic[ x ][ y ] )
  if( ChromaFormatIdc != 0 )
    for( x = 0; x< CroppedWidth / SubWidthC; x++ )
      for( y = 0; y < CroppedHeight / SubHeightC; y++ ) {
        InputDriveCb[ x][ y ] = InpC( driveCroppedCbPic[ x][ y ] )
        InputDriveCr[ x][ y ] = InpC( driveCroppedCrPic[ x ][ y ] )
      }
When gfv_base_pic_flag is equal to 0, the keypoint coordinate array inputDriveKeyPoint
and the matrix inputDriveMatrix for the current picture are derived as follows:
  for( i = 0; i < = convNumKeyPoint; i++ ) {
    inputDriveKeyPoint[ i ][ 0 ] = convKeyPoint[ i ][ 0 ]
    inputDriveKeyPoint [ i ][ 1 ] = convKeyPoint[ i ][ 1 ]
    inputDriveKeyPoint [ i ][ 2 ] = convKeyPoint[ i ][ 2 ]
  }
  for( j = 0; j < convNumMatrix; j++ )
    for( k = 0; k < convMatrixHeight; k++ )
      for( m = 0; m < convMatrixWidth; m++ )
        inputDriveMatrix [ j ][ k ][ m ] = convMatrix [ j ][ k ][ m ]
When gfv_base_pic_flag is equal to 1, the keypoint coordinate array inputBaseKeyPoint
and the matrix inputBaseMatrix for the base picture are derived as follows:
  for( i = 0; i <= convNumKeyPoint; i++ ) {
    inputBaseKeyPoint[ i ][ 0 ] = convKeyPoint[ i ][ 0 ]
    inputBaseKeyPoint [ i ][ 1 ] = convKeyPoint[ i ][ 1 ]
    inputBaseKeyPoint [ i ][ 2 ] = convKeyPoint[ i ][ 2 ]
  }
  for( j = 0; j < convNumMatrix; j++ )
    for( k = 0; k < convMatrixHeight; k++ )
      for( l = 0; l < convMatrixWidth; l++ )
        inputBaseMatrix[ j ][ k ][ l ] = convMatrix [ j ][ k ][ l ]
Where the functions InpY( ) and InpC( ) are specified as follows:
  InpY( x ) = x ÷ ( ( 1 << BitDepth_{Y} ) − 1 )
  InpC( x ) = x ÷ ( ( 1 << BitDepth_{C} ) − 1 )
GenerativeNN() is a process to generate the sample values of an output picture
corresponding to a driving picture. It is only invoked when gfc_base_pic_flag is equal to 0.
Input values to GenerativeNN( ) and output values from GenerativeNN( ) are real numbers.
Inputs to GenerativeNN( ) are:
- When gfv_base_pic_flag is equal to 0, gfv_drive_pic_fusion_flag is equal to 0, and
ChromaFormatIdc is equal to 0: inputBaseY, inputBaseKeyPoint, inputBaseMatrix,
inputDriveKeyPoint, inputDriveMatrix, CroppedWidth, CroppedHeight,and
CroppedDepth.
- When gfv_base_pic_flag is equal to 0, gfv_drive_pic_fusion_flag is equal to 0, and
ChromaFormatIdc is not equal to 0: inputBaseY, inputBaseCb, inputBaseCr,
inputBaseKeyPoint, inputBaseMatrix, inputDriveKeyPoint, inputDriveMatrix,
CroppedWidth, CroppedHeight, and CroppedDepth.
- When gfv_base_pic_flag is equal to 0, gfv_drive_pic_fusion_flag is equal to 1,
gfv_chroma_key_info_present_flag is equal to 0, and ChromaFormatIdc is equal to 0:
inputBaseY, inputDriveY, inputBaseKeyPoint, inputBaseMatrix, inputDriveKeyPoint,
inputDriveMatrix, CroppedWidth, CroppedHeight, and CroppedDepth.
- When gfv_base_pic_flag is equal to 0, gfv_drive_pic_fusion_flag is equal to 1,
gfv_chroma_key_info_present_flag is equal to 0, and ChromaFormatIdc is not equal to
0: inputBaseY, inputBaseCb, inputBaseCr, inputDriveY, inputDriveCb, inputDriveCr ,
inputBaseKeyPoint, inputBaseMatrix,, inputDriveKeyPoint, inputDriveMatrix,
CroppedWidth, CroppedHeight, and CroppedDepth.
- When gfv_base_pic_flag is equal to 0, gfv_drive_pic_fusion_flag is equal to 1,
gfv_chroma_key_info_present_flag is equal to 1, and ChromaFormatIdc is equal to 0:
inputBaseY, inputDriveY, inputBaseKeyPoint, inputBaseMatrix, inputDriveKeyPoint,
inputDriveMatrix, CroppedWidth, CroppedHeight, CroppedDepth,
gfv_chroma_key_thr_value[ 0 ], gfv_chroma_key_thr_value[ 1 ], and
GfvChromaKeyValue[ 0 ].
- When gfv_base_pic_flag is equal to 0, gfv_drive_pic_fusion_flag is equal to 1,
gfv_chroma_key_info_present_flag is equal to 0, and ChromaFormatIdc is not equal to
0: inputBaseY, inputBaseCb, inputBaseCr, inputDriveY, inputDriveCb, inputDriveCr ,
inputBaseKeyPoint, inputBaseMatrix, inputDriveKeyPoint, inputDriveMatrix,
CroppedWidth, CroppedHeight, CroppedDepth, gfv_chroma_key_thr_value[ 0 ],
gfv_chroma_key_thr_value[ 1 ], and, when specified, GfvChromaKeyValue[ 0 ],
GfvChromaKeyValue[ 1 ], and GfvChromaKeyValue[ 2 ].
Outputs of GenerativeNN() are:
- A luma sample array gen Y
- When ChromaFormatIdc is not equal to 0, two chroma sample arrays genCb and genCr.
The process StoreOutputTensors( ) for deriving the output is specified as follows:
When gfv_base_pic_flag is equal to 0, the output sample array outYPic[ x ][ y ],
outCbPic[ x ][ y ], and outCrPic[ x ][ y ] are derived as follows:
  for( x= 0; x < CroppedWidth; x++ )
      for( y = 0; y < CroppedHeight; y++ )
        outputYPic[ x ][ y ] = OutY( gen Y[ x ][ y ] )
  if( ChromaFormatIdc != 0 )
      for( x = 0; x < CroppedWidth / Sub WidthC; x++ )
        for( y = 0; y < CroppedHeight / SubHeightC; y++ ) {
          outputCbPic[ x ][ y ] = OutC( genCb[ x ][ y ]
          outputCrPic[ x][ y ] = OutC( genCr[ x ][ y ] )
        }
When gfv_base_pic_flag is equal to 1, the output sample array outYPic[ x ][ y ],
outCbPic[ x ][ y ], and outCrPic[ x ][ y ] are derived as follows (each output picture
derived by the process StoreOutputTensors( ) is referred to as a GFV-generated picture):
  for( x = 0; x< CroppedWidth; x++ )
      for( y = 0; y< CroppedHeight; y++ )
        outputYPic[ x ][ y ] = baseCroppedYPic[ x ][ y ]
  if( ChromaFormatIdc != 0
      for( x = 0; x< CroppedWidth / SubWidthC; x++ )
        for( y = 0; y< CroppedHeight / SubHeightC; y++ ) {
          outputCbPic[ x ][ y ] = baseCroppedCbPic[ x ][ y ]
          outputCrPic[ x][ y ] = baseCroppedCbPic[ x ][ y ]
      }
Where the functions OutY( ) and OutC( ) are specified as follows:
    OutY( x ) = Clip3( 0, ( 1 << BitDepth_{Y} ) − 1 , x * ( ( 1 << BitDepth_{Y} ) − 1 )
    OutC( x ) = Clip3( 0, ( 1 << BitDepth_{C} ) − 1 , x * ( ( 1 << BitDepth_{C} ) − 1 )
The output order of GFV-generated pictures corresponding to the GFV SEI messages in a
picture unit with the same gfv_id value and different gfv_cnt values shall be in increasing
order of the gfv_cnt values. For any two pictures picA and picB wherein picA precedes
picB in output order, any GFV-generated picture corresponding to a GFV SEI message
with a particular gfv_id value and associated with picA shall precede, in output order, any
GFV-generated picture corresponding to a GFV SEI message with the particular gfv_id
value and associated with picB.
```

The generative face video SEI message has a problem in that redundancy exists in the conditions for the presence of matrix information included in the generative face video SEI message, which may lead to unnecessary operations during the implementation process. Here, the matrix information may be a concept including gfv_coordinate_precision_factor_minus1 to gfv_matrix_for_3D_space_flag[i] in Table 1. As an example, the matrix information may be signaled when a base picture flag (gfv_base_pic_flag) is equal to 1 or when a matrix prediction flag (gfv_matrix_pred_flag) is equal to 0. In this case, the matrix prediction flag may be signaled when the base picture flag is equal to 0, and when the matrix prediction flag is not signaled (in other words, when the base picture flag is equal to 1), the value of the matrix prediction flag may be inferred as 0. Accordingly, the case where the base picture flag is equal to 1 and the case where the matrix prediction flag is equal to 0 may correspond to the same condition, and unnecessary operations may occur during the implementation process due to the redundancy of such conditions.

A method for the generative face video SEI message to remove the redundancy in the conditions for the presence of matrix information included in the generative face video SEI message will be described in the following embodiments.

### Embodiment 1

Table 3 is an example of a generative face video SEI message included in a bitstream.

TABLE 3

| | Descriptor |
|---|---|
| generative_face_video ( payloadSize ) { | |
| ... | |
| gfv_matrix_present_flag | u(1) |
| if( gfv_matrix_present_flag ) { | |
| if( !gfv_base_pic_flag ) | |
| gfv_matrix_pred_flag | u(1) |
| if( !gfv_matrix_pred_flag ) { | |
| gfv_matrix_element_precision_factor_minus1 | ue(v) |
| gfv_num_matrix_types_minus1 | ue(v) |
| for( i = 0; i <= num_matrix_types_minus1; i++ ) { | |
| gfv_matrix_type_idx[ i ] | u(6) |
| if( gfv_matrix_type_idx[ i ] = = 0 \| \| gfv_matrix_type_idx[ i ] = = 1 ) { | |
| if( gfv_coordinate_present_flag ) | |
| gfv_num_matrices_equal_to_num_kps_flag[ i ] | u(1) |
| if( !gfv_num_matrices_equal_to_num_kps_flag[ i ] ) | |
| gfv_num_matrices_info[ i ] | ue(v) |
| } else | |
| if( gfv_matrix_type_idx[ i ] = = 2 \| \| gfv_matrix_type_idx[ i ] = = 3 \| \| | |
| gfv_matrix_type_idx[ i ] >= 7 ) { | |
| if( gfv_matrix_type_idx[ i ] >= 7 ) | |
| gfv_num_matrices_minus1[ i ] | ue(v) |
| gfv_matrix_width_minus1[ i ] | ue(v) |
| gfv_matrix_height_minus1[ i ] | ue(v) |
| } else | |
| if( gfv_matrix_type_idx[ i] >= 4 && gfv_matrix_type_idx[ i ] <= 6 && | |
| !gfv_coordinate_present_flag ) | |
| gfv_matrix_for_3D_space_flag[ i ] | u(1) |
| } | |
| } | |
| . . . | |

A generative face video SEI message may include a matrix present flag (gfv_matrix_present_flag). The matrix present flag may indicate whether a matrix parameter is present. As an example, gfv_matrix_present_flag being equal to 1 may indicate that the matrix parameter is present, and gfv_matrix_present_flag being equal to 0 may indicate that the matrix parameter is not present. Here, the matrix parameter may be a concept including at least one of gfv_matrix_pred_flag, gfv_matrix_element_precision_factor_minus1, gfv_num_matrix_types_minus1, gfv_matrix_type_idx[i], gfv_num_matrices_equal_to_num_kps_flag[i], gfv_num_matrices_info[i], gfv_num_matrices_minus1[i], gfv_matrix_width_minus1[i], gfv_matrix_height_minus1[i], or gfv_matrix_for_3D_space_flag[i].

The generative face video SEI message may include a base picture flag (gfv_base_pic_flag). The base picture flag may indicate whether a currently decoded output picture corresponds to a base picture. As an example, a value of gfv_base_pic_flag being equal to 1 may indicate that the currently decoded output picture corresponds to the base picture. In addition, the value of gfv_base_pic_flag being equal to 0 may indicate that the currently decoded output picture does not correspond to the base picture, or may indicate that the current generative face video SEI message does not include a syntax element for the base picture. When gfv_base_pic_flag is not present in the current generative face video SEI message, the value of gfv_base_pic_flag may be inferred as 0.

The generative face video SEI message may include a matrix prediction flag (gfv_matrix_pred_flag). The matrix prediction flag may indicate whether a matrix element value is signaled based on matrix element difference value information. As an example, a value of gfv_matrix_pred_flag being equal to 1 may indicate that the matrix element difference value information is present, and the value of gfv_matrix_pred_flag being equal to 0 may indicate that matrix element value information is present. In addition, the value of gfv_matrix_pred_flag being equal to 1 may indicate that a matrix element difference value sign flag (gfv_matrix_delta_element_sign_flag[i][j][k][m]) may be present, and the value of gfv_matrix_pred_flag being equal to 0 may indicate that a matrix element value sign flag (gfv_matrix_element_sign_flag[i][j][k][m]) may be present.

The matrix element difference value information may include at least one of matrix element integer difference value information (gfv_matrix_delta_element_int[i][j][k][m]) or matrix element decimal difference value information (gfv_matrix_delta_element_dec[i][j][k][m]), and the matrix element value information may include at least one of matrix element integer value information (gfv_matrix_element_int[i][j][k][m]) or matrix element decimal value information (gfv_matrix_element_dec[i][j][k][m]).

gfv_matrix_delta_element_int[i][j][k][m] may indicate an integer part of a difference value of a matrix element corresponding to an (m, k) position in a j-th matrix of an i-th matrix type. A value of gfv_matrix_delta_element_int[i][j][k][m] may range from 0 to 2³²−2. gfv_matrix_delta_element_dec[i][j][k][m] may indicate a decimal part of the difference value of the matrix element corresponding to the (m, k) position in the j-th matrix of the i-th matrix type. A value of gfv_matrix_delta_element_dec[i][j][k][m] may range from 0 to 2³²−2. gfv_matrix_delta_element_sign_flag[i][j][k][m] may indicate a sign of the difference value of the matrix element corresponding to the (m, k) position in the j-th matrix of the i-th matrix type. When gfv_matrix_delta_element_sign_flag[i][j][k][m] is not present, the value of gfv_matrix_delta_element_sign_flag[i][j][k][m] may be inferred as 0.

gfv_matrix_element_int[i][j][k][m] may indicate an integer part of a value of a matrix element corresponding to an (m, k) position in a j-th matrix of an i-th matrix type. A value of gfv_matrix_element_int[i][j][k][m] may range from 0 to 2³²−2. gfv_matrix_element_dec[i][j][k][m] may indicate a decimal part of the value of the matrix element corresponding to the (m, k) position in the j-th matrix of the i-th matrix type. A bit length of gfv_matrix_element_dec[i][j][k][m] may be a value of gfv_matrix_element_precision_factor_minus1 plus 1. gfv_matrix_element_sign_flag[i][j][k][m] may indicate a sign of the matrix element corresponding to the (m, k) position in the j-th matrix of the i-th matrix type. When gfv_matrix_element_sign_flag[i][j][k][m] is not present, the value of gfv_matrix_element_sign_flag[i][j][k][m] may be inferred as 0.

gfv_matrix_pred_flag may be signaled based on gfv_matrix_present_flag and gfv_base_pic_flag. For example, gfv_matrix_pred_flag may be signaled when gfv_matrix_present_flag is equal to 1 and gfv_base_pic_flag is equal to 0, and may not be signaled when gfv_matrix_present_flag is equal to 0 or gfv_base_pic_flag is equal to 1. When gfv_matrix_pred_flag is not present, the value of gfv_matrix_pred_flag may be inferred as 0.

When gfv_matrix_present_flag included in a current generative face video SEI message is equal to 1, gfv_base_pic_flag is equal to 0, and gfv_matrix_pred_flag is equal to 1, a previous generative face video SEI message in decoding order within a current CLVS with the same gfv_id as the current generative face video SEI message and gfv_base_pic_flag equal to 1 shall be present.

The generative face video SEI message may include matrix precision information (gfv_matrix_element_precision_factor_minus1). The matrix precision information may indicate a precision of a matrix element signaled in the generative face video SEI message. As an example, a value of gfv_matrix_element_precision_factor_minus1 plus 1 may indicate the precision of the matrix element signaled in the generative face video SEI message. A value of gfv_matrix_element_precision_factor_minus1 shall be in a range of 0 to 31.

gfv_matrix_element_precision_factor_minus1 may be signaled based on gfv_matrix_pred_flag. For example, gfv_matrix_element_precision_factor_minus1 may be signaled when gfv_matrix_pred_flag is equal to 0, and may not be signaled when gfv_matrix_pred_flag is equal to 1. In this case, gfv_matrix_element_precision_factor_minus1 may not be signaled when gfv_matrix_pred_flag is equal to 1, regardless of a value of gfv_base_pic_flag.

When gfv_matrix_present_flag included in a current generative face video SEI message is equal to 1, gfv_base_pic_flag is equal to 0, and gfv_matrix_pred_flag is equal to 1, a value of gfv_matrix_element_precision_factor_minus1 of the current generative face video SEI message may be inferred to be equal to a value of gfv_matrix_element_precision_factor_minus1 of a previous generative face video SEI message in decoding order with the same gfv_id as the current generative face video SEI message and gfv_base_pic_flag equal to 1.

The generative face video SEI message may include matrix type number information (gfv_num_matrix_types_minus1). The matrix type number information may indicate a number of matrix types signaled in the generative face video SEI message. As an example, a value of gfv_num_matrix_types_minus1 plus 1 may indicate the number of matrix types signaled in the generative face video SEI message. A value of gfv_num_matrix_types_minus1 shall be in a range of 0 to 26-1.

gfv_num_matrix_types_minus1 may be signaled based on gfv_matrix_pred_flag. For example, gfv_num_matrix_types_minus1 may be signaled when gfv_matrix_pred_flag is equal to 0, and may not be signaled when gfv_matrix_pred_flag is equal to 1. In this case, gfv_num_matrix_types_minus1 may not be signaled when gfv_matrix_pred_flag is equal to 1, regardless of a value of gfv_base_pic_flag.

When gfv_matrix_pred_flag included in a current generative face video SEI message is equal to 1 and gfv_base_pic_flag is equal to 0, a value of gfv_num_matrix_types_minus1 shall be equal to a value of gfv_num_matrix_types_minus1 of a previous generative face video SEI message in decoding order within a current CLVS with the same gfv_id as the current generative face video SEI message and gfv_base_pic_flag equal to 1.

In addition, when gfv_matrix_present_flag included in the current generative face video SEI message is equal to 1, gfv_base_pic_flag is equal to 0, and gfv_matrix_pred_flag is equal to 1, the value of gfv_num_matrix_types_minus1 may be inferred to be equal to the value of gfv_num_matrix_types_minus1 of the previous generative face video SEI message in decoding order with the same gfv_id as the current generative face video SEI message and gfv_base_pic_flag equal to 1.

The generative face video SEI message may include matrix type information (gfv_matrix_type_idx[i]). The matrix type information may indicate a type of a i-th signaled matrix in the generative face video SEI message. As an example, the type of the i-th signaled matrix (hereinafter, an i-th matrix type) may be determined with reference to Table 4 according to a value of gfv_matrix_type_idx[i]. Here, the i may represent an index for distinguishing each matrix type among a plurality of matrix types included in the generative face video SEI message.

TABLE 4

| Value | Specification |
|---|---|
| 0 | Affine translation matrix with the size of 2*2 or 3*3. |
| 1 | Covariance matrix with size of 2*2 or 3*3. |
| 2 | Mouth matrix representing mouth motion. |
| 3 | Eye matrix representing the open-close status and level |
| | of eyes. |
| 4 | Head rotation paramters with the size of 2*2 or 3*3 |
| | representing the head rotation in 2D space or 3D space. |
| 5 | Head translation matrix with the size of 1*2 or 1*3 |
| | representing head translationin 2D space or 3D space. |
| 6 | Head location matrix with size of 1*2 or 1*3 representing |
| | the head location in 2D space or 3D space. |
| 7 | Compact feature matrix with the size being specified by |
| | gfv_matrix_width_minus1[i] and |
| | gfv_matrix_height_minus1[i]. |
| 8 . . . 31 | Other matrix that may be used as determined by the |
| | application with the size being specified by |
| | gfv_matrix_width_minus1[i] and |
| | gfv_matrix_height_minus1[i]. |
| 32 . . . 63 | Reserved |

Referring to Table 4, a value of gfv_matrix_type_idx[i] shall be in a range of 0 to 63. However, in a bitstream according to the present disclosure, the value of gfv_matrix_type_idx[i] shall be in a range of 0 to 31, and values in a range of 32 to 63 may be reserved for future use. In addition, an image decoding apparatus according to the present disclosure shall allow gfv_matrix_type_idx[i] with a value greater than or equal to 31 to be present in the bitstream, and shall ignore all information related to an i-th matrix type corresponding to gfv_matrix_type_idx[i] with a value greater than or equal to 31.

gfv_matrix_type_idx[i] may be signaled based on at least one of gfv_matrix_pred_flag or gfv_num_matrix_types_minus1. For example, gfv_matrix_type_idx[i] may be signaled when gfv_matrix_pred_flag is equal to 0, and may not be signaled when gfv_matrix_pred_flag is equal to 1. In this case, gfv_matrix_type_idx[i] may not be signaled when gfv_matrix_pred_flag is equal to 1, regardless of a value of gfv_base_pic_flag. gfv_matrix_type_idx[i] may be signaled as many times as the number of matrix types signaled in a current generative face video SEI message according to gfv_num_matrix_types_minus1.

The generative face video SEI message may include a matrix-keypoint number equality flag (gfv_num_matrices_equal_to_num_kps_flag[i]). The matrix-keypoint number equality flag may indicate whether a number of matrices by i-th matrix type is equal to a number of keypoints. Here, keypoint number information (gfv_num_kps_minus1) included in the generative face video SEI message may indicate the number of keypoints. As an example, a value of gfv_num_kps_minus1 plus 1 may be the number of keypoints.

As an example, gfv_num_matrices_equal_to_num_kps_flag[i] equal to 1 may indicate that the number of matrices by i-th signaled matrix type is equal to a value of gfv_num_kps_minus1 plus 1, and gfv_num_matrices_equal_to_num_kps_flag[i] equal to 0 may indicate that the number of matrices by i-th signaled matrix type is not equal to the value of gfv_num_kps_minus1 plus 1.

gfv_num_matrices_equal_to_num_kps_flag[i] may be signaled based on at least one of gfv_matrix_pred_flag, gfv_num_matrix_types_minus1, gfv_matrix_type_idx[i], or gfv_coordinate_present_flag. For example, gfv_num_matrices_equal_to_num_kps_flag[i] may be signaled when gfv_matrix_pred_flag is equal to 0, and may not be signaled when gfv_matrix_pred_flag is equal to 1. In this case, gfv_num_matrices_equal_to_num_kps_flag[i] may not be signaled when gfv_matrix_pred_flag is equal to 1, regardless of a value of gfv_base_pic_flag. gfv_num_matrices_equal_to_num_kps_flag[i] may be signaled as many times as the number of matrix types signaled in a current generative face video SEI message according to gfv_num_matrix_types_minus1.

As another example, gfv_num_matrices_equal_to_num_kps_flag[i] may be signaled when gfv_matrix_type_idx[i] is equal to 0 or 1 and gfv_coordinate_present_flag is equal to 1, and may not be signaled in at least one case where gfv_matrix_type_idx[i] is greater than 1 or gfv_coordinate_present_flag is equal to 0. Here, a keypoint information present flag (gfv_coordinate_present_flag) included in the generative face video SEI message may indicate whether coordinate information of keypoint is present. As an example, gfv_coordinate_present_flag equal to 1 may indicate that the coordinate information of the keypoint is present.

When gfv_matrix_present_flag included in a current generative face video SEI message is equal to 1, gfv_base_pic_flag is equal to 0, gfv_matrix_pred_flag is equal to 1, gfv_matrix_type_idx[i] is equal to 0 or 1, and gfv_coordinate_present_flag is equal to 1, a value of gfv_num_matrices_equal_to_num_kps_flag[i] may be inferred to be equal to a value of gfv_num_matrices_equal_to_num_kps_flag[i] of a previous generative face video SEI message in decoding order with the same gfv_id as the current generative face video SEI message and gfv_base_pic_flag equal to 1.

Alternatively, when gfv_num_matrices_equal_to_num_kps_flag[i] is not present, the value of gfv_num_matrices_equal_to_num_kps_flag[i] may be inferred as 0.

The generative face video SEI message may include matrix number derivation information by matrix type (gfv_num_matrices_info[i]). The matrix number derivation information by matrix type may provide information for deriving a number of matrices by i-th matrix type. A value of gfv_num_matrices_info[i] shall be in a range of 0 to 210-1.

gfv_num_matrices_info[i] may be signaled based on at least one of gfv_matrix_pred_flag, gfv_num_matrix_types_minus1, or gfv_num_matrices_equal_to_num_kps_flag[i]. For example, gfv_num_matrices_info[i] may be signaled when gfv_matrix_pred_flag is equal to 0, and may not be signaled when gfv_matrix_pred_flag is equal to 1. In this case, gfv_num_matrices_info[i] may not be signaled when gfv_matrix_pred_flag is equal to 1, regardless of a value of gfv_base_pic_flag.

As another example, gfv_num_matrices_info[i] may be signaled when gfv_num_matrices_equal_to_num_kps_flag[i] is equal to 0, and may not be signaled when gfv_num_matrices_equal_to_num_kps_flag[i] is equal to 1. gfv_num_matrices_info[i] may be signaled as many times as the number of matrix types signaled in a current generative face video SEI message according to gfv_num_matrix_types_minus1.

When gfv_matrix_present_flag included in the current generative face video SEI message is equal to 1, gfv_base_pic_flag is equal to 0, gfv_matrix_pred_flag is equal to 1, gfv_matrix_type_idx[i] is equal to 0 or 1, and at least one of gfv_coordinate_present_flag or gfv_num_matrices_equal_to_num_kps_flag[i] is equal to 0, a value of gfv_num_matrices_info[i] may be inferred to be equal to a value of gfv_num_matrices_info[i] in a previous generative face video SEI message in decoding order with the same gfv_id as the current generative face video SEI message and gfv_base_pic_flag equal to 1.

The generative face video SEI message may include matrix related information by matrix type. Here, the matrix related information by matrix type may include at least one of matrix number information (gfv_num_matrices_minus1[i]) indicating a number of matrices by matrix type, matrix width information (gfv_matrix_width_minus1[i]) indicating a width of the matrix by matrix type, or matrix height information (gfv_matrix_height_minus1[i]) indicating a height of the matrix by matrix type.

The generative face video SEI message may include the matrix number information (gfv_num_matrices_minus1[i]). The matrix number information may indicate the number of matrices by i-th matrix type. As an example, a value of gfv_num_matrices_minus1[i] plus 1 may indicate the number of matrices by i-th matrix type. A value of gfv_num_matrices_minus1[i] shall be in a range of 0 to 2¹⁰−1.

gfv_num_matrices_minus1[i] may be signaled based on at least one of gfv_matrix_pred_flag, gfv_num_matrix_types_minus1, or gfv_matrix_type_idx[i]. For example, gfv_num_matrices_minus1[i] may be signaled when gfv_matrix_pred_flag is equal to 0, and may not be signaled when gfv_matrix_pred_flag is equal to 1. In this case, gfv_num_matrices_minus1[i] may not be signaled when gfv_matrix_pred_flag is equal to 1, regardless of a value of gfv_base_pic_flag.

As another example, gfv_num_matrices_minus1[i] may be signaled when gfv_matrix_type_idx[i] is greater than or equal to 7, and may not be signaled when gfv_matrix_type_idx[i] is less than 7. gfv_num_matrices_minus1[i] may be signaled as many times as the number of matrix types signaled in a current generative face video SEI message according to gfv_num_matrix_types_minus1.

When gfv_matrix_present_flag included in the current generative face video SEI message is equal to 1, gfv_base_pic_flag is equal to 0, gfv_matrix_pred_flag is equal to 1, and gfv_matrix_type_idx[i] is greater than or equal to 7, a value of gfv_num_matrices_minus1[i] may be inferred to be equal to a value of gfv_num_matrices_minus1[i] of a previous generative face video SEI message in decoding order with the same gfv_id as the current generative face video SEI message and gfv_base_pic_flag equal to 1.

The generative face video SEI message may include matrix width information (gfv_matrix_width_minus1[i]). The matrix width information may indicate a width of a matrix by i-th matrix type. As an example, a value of gfv_matrix_width_minus1[i] may indicate the width of the matrix by i-th matrix type. A value of gfv_matrix_width_minus1[i] shall be in a range of 0 to 2¹⁰−1.

gfv_matrix_width_minus1[i] may be signaled based on at least one of gfv_matrix_pred_flag, gfv_num_matrix_types_minus1, or gfv_matrix_type_idx[i]. For example, gfv_matrix_width_minus1[i] may be signaled when gfv_matrix_pred_flag is equal to 0, and may not be signaled when gfv_matrix_pred_flag is equal to 1. In this case, gfv_matrix_width_minus1[i] may not be signaled when gfv_matrix_pred_flag is equal to 1, regardless of a value of gfv_base_pic_flag.

As another example, gfv_matrix_width_minus1[i] may be signaled when gfv_matrix_type_idx[i] is equal to 2, is equal to 3, or is greater than or equal to 7, and may not be signaled when gfv_matrix_type_idx[i] is equal to 0, 1, 4, 5, or 6. gfv_matrix_width_minus1[i] may be signaled as many times as the number of matrix types signaled in a current generative face video SEI message according to gfv_num_matrix_types_minus1.

When gfv_matrix_present_flag included in the current generative face video SEI message is equal to 1, gfv_base_pic_flag is equal to 0, gfv_matrix_pred_flag is equal to 1, and gfv_matrix_type_idx[i] is equal to 2, is equal to 3, or is greater than or equal to 7, a value of gfv_matrix_width_minus1[i] may be inferred to be equal to a value of gfv_matrix_width_minus1[i] of a previous generative face video SEI message in decoding order with the same gfv_id as the current generative face video SEI message and gfv_base_pic_flag equal to 1.

The generative face video SEI message may include matrix height information (gfv_matrix_height_minus1[i]). The matrix height information may indicate a height of a matrix by i-th matrix type. As an example, a value of gfv_matrix_height_minus1[i] plus 1 may indicate the height of the matrix by i-th matrix type. A value of gfv_matrix_height_minus1[i] shall be in a range of 0 to 2¹⁰−1.

gfv_matrix_height_minus1[i] may be signaled based on at least one of gfv_matrix_pred_flag, gfv_num_matrix_types_minus1, or gfv_matrix_type_idx[i]. For example, gfv_matrix_height_minus1[i] may be signaled when gfv_matrix_pred_flag is equal to 0, and may not be signaled when gfv_matrix_pred_flag is equal to 1. In this case, gfv_matrix_height_minus1[i] may not be signaled when gfv_matrix_pred_flag is equal to 1, regardless of a value of gfv_base_pic_flag.

As another example, gfv_matrix_height_minus1[i] may be signaled when gfv_matrix_type_idx[i] is equal to 2, is equal to 3, or is greater than or equal to 7, and may not be signaled when gfv_matrix_type_idx[i] is equal to 0, 1, 4, 5, or 6.

gfv_matrix_height_minus1[i] may be signaled as many times as the number of matrix types signaled in a current generative face video SEI message according to gfv_num_matrix_types_minus1.

When gfv_matrix_present_flag included in the current generative face video SEI message is equal to 1, gfv_base_pic_flag is equal to 0, gfv_matrix_pred_flag is equal to 1, and gfv_matrix_type_idx[i] is equal to 2, is equal to 3, or is greater than or equal to 7, a value of gfv_matrix_height_minus1[i] may be inferred to be equal to a value of gfv_matrix_height_minus1[i] of a previous generative face video SEI message in decoding order with the same gfv_id as the current generative face video SEI message and gfv_base_pic_flag equal to 1.

The generative face video SEI message may include a 3D matrix flag (gfv_matrix_for_3D_space_flag[i]). The 3D matrix flag may indicate whether a matrix of i-th matrix type is a matrix defined in a 3D space. As an example, gfv_matrix_for_3D_space_flag[i] being equal to 1 may indicate that the matrix of the i-th matrix type is a matrix defined in a 3D space, and gfv_matrix_for_3D_space_flag[i] being equal to 0 may indicate that the matrix of the i-th matrix type is a matrix defined in a 2D space.

gfv_matrix_for_3D_space_flag[i] may be signaled based on at least one of gfv_matrix_pred_flag, gfv_num_matrix_types_minus1, gfv_matrix_type_idx[i], or gfv_coordinate_present_flag. For example, gfv_matrix_for_3D_space_flag[i] may be signaled when gfv_matrix_pred_flag is equal to 0, and may not be signaled when gfv_matrix_pred_flag is equal to 1. In this case, gfv_matrix_for_3D_space_flag[i] may not be signaled when gfv_matrix_pred_flag is equal to 1, regardless of a value of gfv_base_pic_flag.

As another example, gfv_matrix_for_3D_space_flag[i] may be signaled when gfv_matrix_type_idx[i] is equal to any one of 4, 5, or 6 and gfv_coordinate_present_flag is equal to 0, and may not be signaled when gfv_matrix_type_idx[i] is less than 4, gfv_matrix_type_idx[i] is greater than 6, or gfv_coordinate_present_flag is equal to 1. gfv_matrix_for_3D_space_flag[i] may be signaled as many times as the number of matrix types signaled in a current generative face video SEI message according to gfv_num_matrix_types_minus1.

When gfv_matrix_present_flag included in the current generative face video SEI message is equal to 1, gfv_base_pic_flag is equal to 0, gfv_matrix_pred_flag is equal to 1, gfv_matrix_type_idx[i] is equal to 4, 5, or 6, and gfv_coordinate_present_flag is equal to 0, a value of gfv_matrix_for_3D_space_flag[i] may be inferred to be equal to a value of gfv_matrix_for_3D_space_flag[i] of a previous generative face video SEI message in decoding order with the same gfv_id as the current generative face video SEI message and gfv_base_pic_flag equal to 1.

The generative face video SEI message may be included in a network abstraction layer (NAL) unit of a bitstream. However, the present disclosure is not limited thereto. As an example, the generative face video information according to the present disclosure may be configured in a high level syntax of the bitstream. Here, the high level syntax may be at least one of a sequence parameter set (SPS), a picture parameter set (PPS), a picture header (PH), or a slice header (SH). Alternatively, the generative face video SEI message according to the present disclosure may be defined as a separate NAL unit type within the bitstream.

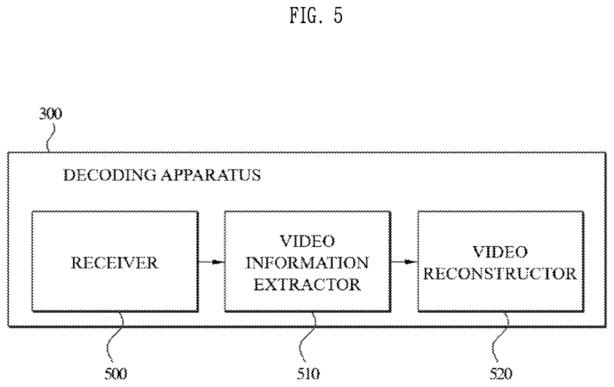

FIG. 5 illustrates a schematic configuration of a decoding apparatus 300 performing a method of reconstructing a video picture, according to the present disclosure.

Referring to FIG. 5, the decoding apparatus 300 may include a receiver 500, a video information extractor 510, and a video reconstructor 520.

The receiver 500 may receive a bitstream including an encoded video picture.

The video information extractor 510 may extract video information related to the encoded video picture from the bitstream. In addition, the video information extractor 510 may extract generative face video information from the bitstream, as described with reference to FIG. 4.

The video reconstructor 520 may reconstruct the encoded video picture based on the extracted video information.

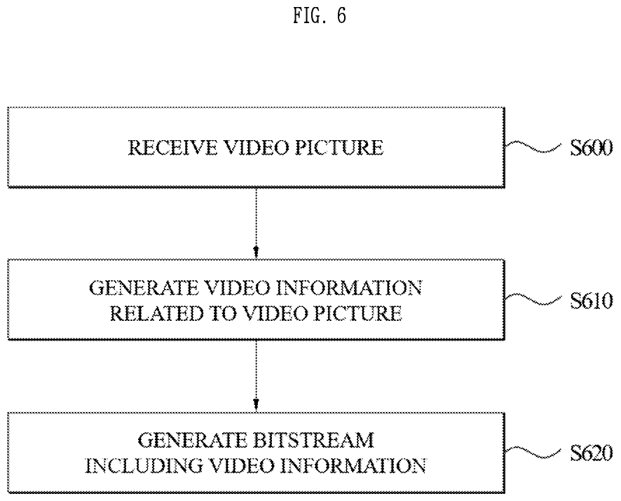

FIG. 6 illustrates a method of generating a bitstream performed by an encoding apparatus 200, according to the present disclosure.

A video picture to be encoded may be received S600.

The received video picture may be encoded to generate video information related to the video picture S610.

A bitstream including the video information related to the video picture may be generated S620.

In addition, generative face video information applied to the bitstream may be generated, as described with reference to FIG. 4. The generative face video information may be included in the bitstream.

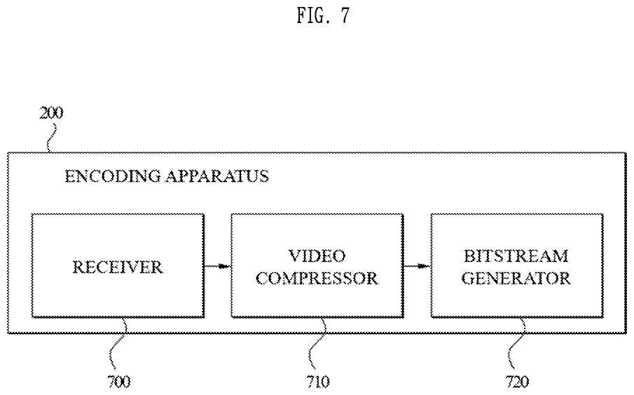

FIG. 7 illustrates a schematic configuration of an encoding apparatus 200 performing a method of generating a bitstream, according to the present disclosure.

Referring to FIG. 7, the encoding apparatus 200 may include a receiver 700, a video compressor 710, and a bitstream generator 720.

The receiver 700 may receive one or more video pictures to be encoded.

The video compressor 710 may encode the received one or more video pictures to generate video information related to the video pictures. The video compressor 710 may generate generative face video information applied to the bitstream.

The bitstream generator 720 may generate a bitstream including the video information. The bitstream generator 720 may generate a bitstream further including the generated generative face video information.

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding apparatus and/or a decoding apparatus according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding apparatus and an encoding apparatus to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VoD) service, an over the top video (OTT) device, a device for providing Internet streaming service, a three-dimensional (3D) video device, a virtual reality (VR) device, an augmented reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

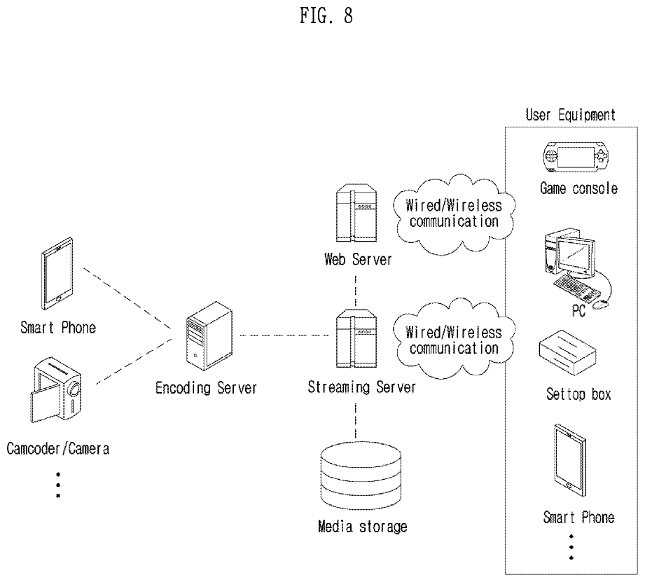

FIG. 8 shows an example of a contents streaming system to which embodiments of the present disclosure may be applied.

Referring to FIG. 8 a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method. In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

What is claimed is:

1. A method comprising:
receiving a bitstream including an encoded video picture; and
reconstructing the encoded video picture included in the bitstream,
wherein the bitstream includes a generative face video supplementary enhancement information (SEI) message,
wherein the generative face video SEI message includes at least one of a base picture flag indicating whether a currently decoded output picture corresponds to a base picture or a matrix prediction flag indicating whether matrix element difference value information is present, and
wherein the generative face video SEI message is obtained from a network abstraction layer (NAL) unit of the bitstream.

2. The method of claim 1,
wherein a value of the matrix prediction flag being equal to 0 indicates that matrix element value information is present,
wherein the value of the matrix prediction flag being equal to 1 indicates that the matrix element difference value information is present,
wherein the matrix element value information includes at least one of matrix element integer value information or matrix element decimal value information, and
wherein the matrix element difference value information includes at least one of matrix element integer difference value information or matrix element decimal difference value information.

3. The method of claim 1,
wherein the generative face video SEI message includes matrix precision information indicating a precision of a matrix element, and
wherein the matrix precision information is signaled based on the matrix prediction flag.

4. The method of claim 3,
wherein, when a value of the matrix prediction flag is equal to 0, the matrix precision information is signaled, and
wherein, when the value of the matrix prediction flag is equal to 1, regardless of a value of the base picture flag, the matrix precision information is not signaled.

5. The method of claim 1,
wherein the generative face video SEI message includes matrix type number information indicating a number of matrix types, and
wherein the matrix type number information is signaled based on the matrix prediction flag.

6. The method of claim 5,
wherein, when a value of the matrix prediction flag is equal to 0, the matrix type number information is signaled, and
wherein, when the value of the matrix prediction flag is equal to 1, regardless of a value of the base picture flag, the matrix type number information is not signaled.

7. The method of claim 5,
wherein the generative face video SEI message includes matrix type information indicating a type of a matrix included in the generative face video SEI message, and
wherein the matrix type information is signaled based on at least one of the matrix prediction flag or the matrix type number information.

8. The method of claim 7,
wherein, when a value of the matrix prediction flag is equal to 0, the matrix type information is signaled, and
wherein, when the value of the matrix prediction flag is equal to 1, regardless of a value of the base picture flag, the matrix type information is not signaled.

9. The method of claim 7,
wherein the generative face video SEI message includes matrix related information by matrix type,
wherein the matrix related information by matrix type is signaled based on at least one of the matrix prediction flag or the matrix type information, and
wherein the matrix related information includes at least one of matrix number information indicating a number of matrices by matrix type, matrix width information indicating a width of a matrix by matrix type, or matrix height information indicating a height of a matrix by matrix type.

10. The method of claim 9,
wherein, when a value of the matrix prediction flag is equal to 0, the matrix related information by matrix type is signaled, and
wherein, when the value of the matrix prediction flag is equal to 1, regardless of a value of the base picture flag, the matrix related information by matrix type is not signaled.

11. The method of claim 9,
wherein, when a value of the matrix type information is greater than or equal to 7, the matrix number information, the matrix width information, and the matrix height information are signaled, and
wherein, when the value of the matrix type information is equal to 2 or 3, the matrix width information and the matrix height information are signaled, and the matrix number information is not signaled.

12. A method comprising:
receiving a video picture to be encoded;
generating video information related to the video picture by encoding the received video picture;
generating a generative face video supplementary enhancement information (SEI) message; and
generating a bitstream including the video information and the generative face video SEI message,
wherein the generative face video SEI message includes at least one of a base picture flag indicating whether a currently decoded output picture corresponds to a base picture or a matrix prediction flag indicating whether matrix element difference value information is present, and
wherein the generative face video SEI message is encoded into a network abstraction layer (NAL) unit of the bitstream.

13. A computer-readable storage medium storing a bitstream generated by the method according to claim 12.

14. A method comprising:
generating a bitstream, wherein the bitstream is generated based on receiving a video picture to be encoded, generating video information related to the video picture by encoding the received video picture, and generating a generative face video supplementary enhancement information (SEI) message; and
transmitting data including the bitstream,
wherein the generative face video SEI message includes at least one of a base picture flag indicating whether a currently decoded output picture corresponds to a base picture or a matrix prediction flag indicating whether matrix element difference value information is present, and
wherein the generative face video SEI message is encoded into a network abstraction layer (NAL) unit of the bitstream.
